(19) United States
(12) Patent Application Publication
(10) Pub. No.: US 2024/0255959 A1
(43) Pub. Date: Aug. 1, 2024

(54) FLIGHT CONTROL METHOD AND DEVICE

(71) Applicant: SZ DJI TECHNOLOGY CO., LTD., Shenzhen (CN)

(72) Inventors: Xiang LI, Shenzhen (CN); Ximin LV, Shenzhen (CN); Wuyang DUAN, Shenzhen (CN); Zhimeng SHANG, Shenzhen (CN)

(73) Assignee: SZ DJI TECHNOLOGY CO., LTD., Shenzhen (CN)

(21) Appl. No.: 18/216,877

(22) Filed: Jun. 30, 2023

Related U.S. Application Data
(63) Continuation of application No. PCT/CN2021/131798, filed on Nov. 19, 2021.
Application No. PCT/CN2021/131798 is a continuation of application No. PCT/CN2020/141835, filed on Dec. 30, 2020.

(51) Int. Cl. G05D 1/65; G05D 1/223; G05D 1/48; G05D 1/689; G05D 109/20; G05D 111/10

(52) U.S. Cl. CPC G05D 1/65; G05D 1/223; G05D 1/484; G05D 1/689; G05D 2109/20; G05D 2111/10

(57) ABSTRACT

A method implemented by a processor associated with a movable object includes receiving a first parameter value from a user interface communicatively coupled to the movable object; determining a horizontal acceleration based on the first parameter value, wherein the horizontal acceleration is substantially zero when the first parameter value is zero; and controlling the movable object to accelerate or decelerate in accordance with the determined horizontal acceleration.

### RELATED APPLICATIONS

This application is a continuation application of PCT application No. PCT/CN2021/131798, filed on Nov. 19, 2021, which claims the benefit of priority of PCT/CN2020/141835, filed on Dec. 30, 2020, and the contents of the foregoing documents are incorporated herein by reference in the entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to systems, apparatuses, and methods of flight control of an unmanned aerial vehicle (UAV).

### BACKGROUND

First-person view (FPV), also known as remote-person view or video piloting, is a method for controlling a vehicle from a driver or pilot's viewpoint (e.g., via an on-board camera). FPV UAVs are UAVs enabled to be controlled by FPV and are popular in racing sports, entertainment, and video content production.

Compared with a non-FPV UAV, flight control of a FPV UAV is more difficult for an unskilled user. To have a smooth flight path, the user may need to apply more precise control of motion status (e.g., a height, a forward speed, a roll angle, or a yaw angle) of the FPV UAV, which can distract the user's focus, e.g., from shooting a video.

### SUMMARY

One aspect of this disclosure is directed to a method implemented by a processor associated with a movable object for controlling a movable object, including: in response to receiving a first parameter value from a first control module of a user interface communicatively coupled to the movable object, controlling the movable object to accelerate or decelerate in a horizontal direction based on the first parameter value; and in response to not receiving the first parameter value from the first control module, controlling the movable object to move at a uniform speed in the horizontal direction.

Another aspect of this disclosure is directed to an apparatus for controlling a movable object, including: at least one non-transitory storage medium storing a set of instructions for controlling the movable object; and at least one processor in communication with the at least one non-transitory storage medium, where during operation, the at least one processor executes the set of instructions to: in response to receiving a first parameter value from a first control module of a user interface communicatively coupled to the movable object, control the movable object to accelerate or decelerate in a horizontal direction based on the first parameter value, and in response to not receiving the first parameter value from the first control module, control the movable object to move at a uniform speed in the horizontal direction.

Yet another aspect of this disclosure is directed to a system, including: a movable object; and a user interface, communicatively coupled to the movable object, where the movable object includes: at least one non-transitory storage medium storing a set of instructions for controlling the movable object; and at least one processor in communication with the at least one non-transitory storage medium, where during operation, the at least one processor executes the set of instructions to: in response to receiving a first parameter value from a first control module of the user interface, control the movable object to accelerate or decelerate in a horizontal direction based on the first parameter value, and in response to not receiving the first parameter value from the first control module, control the movable object to move at a uniform speed in the horizontal direction.

It should be understood that both the foregoing general description and the following detailed description are examples only and are not restrictive of this disclosure, as claimed.

### BRIEF DESCRIPTION OF THE DRAWINGS

FIG. 1 illustrates an example system of a movable object and a corresponding operating environment, in accordance with some exemplary embodiments of the present disclosure.

FIG. 2 illustrates an example movable object including a first body and a second body, consistent with some exemplary embodiments of this disclosure.

FIG. 3 illustrates example paths of a movable object making turns, consistent with some exemplary embodiments of this disclosure.

FIGS. 4A-4C illustrate example diagrams of control path diagrams for controlling a movable object making turns, consistent with some exemplary embodiments of this disclosure.

FIG. 5 illustrates a flowchart of an example method for controlling a horizontal speed of a movable object, consistent with some exemplary embodiments of this disclosure.

FIG. 6 illustrates a flowchart of an example method for controlling turning of a movable object, consistent with some exemplary embodiments of this disclosure.

FIG. 7 illustrates a flowchart of an example method for controlling a vertical speed of a movable object, consistent with some exemplary embodiments of this disclosure.

FIG. 8 illustrates a flowchart of an example method for providing safety protection to a movable object, consistent with some exemplary embodiments of this disclosure.

FIG. 9 illustrates a flowchart of an example method for controlling a movable object, consistent with some exemplary embodiments of this disclosure.

FIG. 10 illustrates a flowchart of another example method for controlling a movable object, consistent with some exemplary embodiments of this disclosure.

### DETAILED DESCRIPTION

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed exemplary embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise. Moreover, the relational terms herein such as “first” and “second” are used only to differentiate an entity or operation from another entity or operation, and do not require or imply any actual relationship or sequence between these entities or operations.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

The following detailed description refers to the accompanying drawings. Wherever possible, the same reference numbers refer to the same or similar parts. While several illustrative embodiments are described herein, modifications, adaptations, and other implementations are possible. For example, substitutions, additions or modifications can be made to the components illustrated in the drawings. Accordingly, the following detailed description is not limited to the disclosed exemplary embodiments and examples. Instead, the proper scope is defined by the appended claims.

An FPV UAV is typically equipped with an on-board camera (e.g., mounted on a gimbal stabilizer or integrated inside the body of the FPV UAV) for providing a first-person viewpoint (e.g., line of sight) during its flight or recording a video clip. For example, the FPV UAV can include a quadcopter (or “quadrotor”). Typically, the FPV UAV can be communicatively coupled to a remote controller that can send and receive radio signals to and from the FPV UAV for controlling a flight status of the FPV UAV or receiving an FPV video feed. The flight status can include parameters such as a position, a posture, a speed, an acceleration, a height, a pitch angle, a roll angle, a yaw angle, or any other parameter related to the motion of the FPV UAV.

Typically, the remote controller can apply a closed-loop (or “feedback”) control technique for controlling the flight status of the FPV UAV. A closed-loop controller includes a feedback loop that closes a forward loop and can exert a control action to manipulate a process variable (e.g., a flight status parameter) to reach a setpoint (e.g., an input control parameter) depending on feedback (e.g., a measurement) of the process variable. For example, a closed-loop controller can be a proportional-integral-derivative (PID) controller that can calculate, in real time, a difference between the setpoint and the measured process variable and applies a correction based on at least one of a proportional, integral, or derivative term associated with the measured process variable.

Existing controllers of FPV UAVs typically do not provide speed feedback for closed-loop controlling. For example, they can provide feedback control of postures of the FPV UAV but cannot provide feedback control of the speed of the FPV UAV, which can cause difficulty for an unskilled user to precisely control the speed, acceleration, or deceleration of the FPV UAV. Also, the existing controllers of FPV UAVs typically do not compensate a roll angle when the FPV UAV receives a signal to change its yaw angle for making banked turns. Thus, the unskilled user can have to control both the yaw angle and the roll angle of the FPV UAV for making banked turns, which is difficult and can cause an unsmooth video feed. Further, the existing controllers of FPV UAVs typically do not provide tailored control logic for ascending, descending, or hovering of the FPV UAV, which cannot satisfy different user needs (e.g., responsiveness of controlling) in ascending, descending, or hovering of the FPV UAV. Moreover, the existing controllers of FPV UAVs typically do not provide extra safety protection in the flight control, which can increase the risk of the unskilled user damaging the FPV UAV.

Consistent with embodiments of the present disclosure, systems, apparatuses, and methods for flight control of a movable object (e.g., an FPV UAV) are provided herein. The disclosed exemplary embodiments can enable controlling the movable object to accelerate or decelerate in accordance with a horizontal acceleration determined based on an input control parameter. The disclosed exemplary embodiments can also enable controlling the movable object to perform a banked turn in accordance with an input parameter representing a yaw angular speed and a roll angle automatically determined based on the yaw angular speed. The disclosed exemplary embodiments can further enable controlling the movable object to ascend when a motor coupled to the movable object rotates at a rotation rate determined based on a relationship between the rotation rate and an input control parameter value. A “rotation” of a motor, as used herein, can include circular motion (e.g., gyrating, revolving, rotating, or spinning) of one or more internal components (e.g., a rotor, a flywheel, or any moving part) of the motor about an axis of the motor to drive a propulsion means (e.g., a propeller). Moreover, the disclosed exemplary embodiments can provide safety protection by disabling the movable object if it moves faster than a speed limit determined based on measured motion data. In some exemplary embodiments, the systems, apparatuses, and methods can also provide interfaces for the user to switch, depending on skill levels and flight scenarios, flight modes in which different flight status parameters can be controlled in accordance with different logics.

The disclosed systems, apparatuses, and methods can reduce the difficulty of flight control by reducing manual control actions and increase flight safety by safety protection mechanisms for a user of the FPV UAV. Thus, the user can focus on flight experience and can enjoy more user-friendly flight control and smooth, video-friendly flight paths. By providing the interfaces to switch the flight modes, the user can also enjoy higher playability and adaptiveness of the FPV UAV.

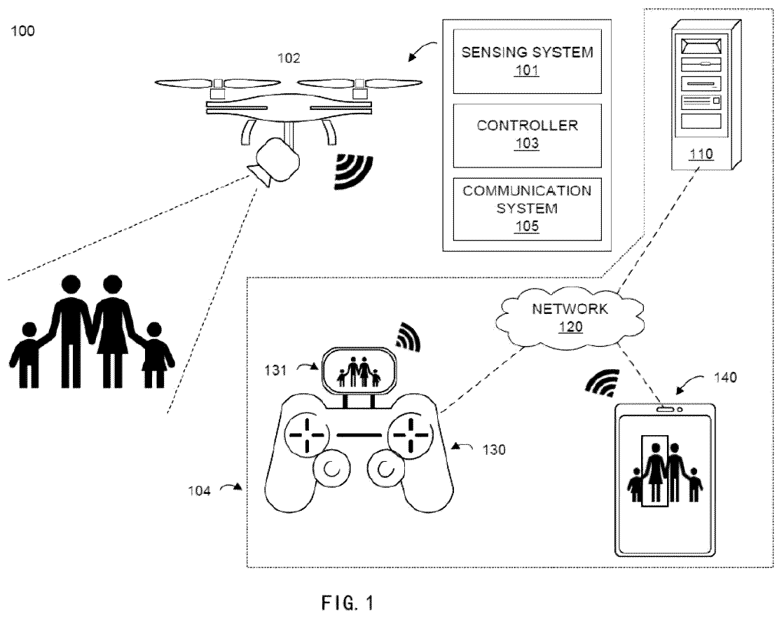

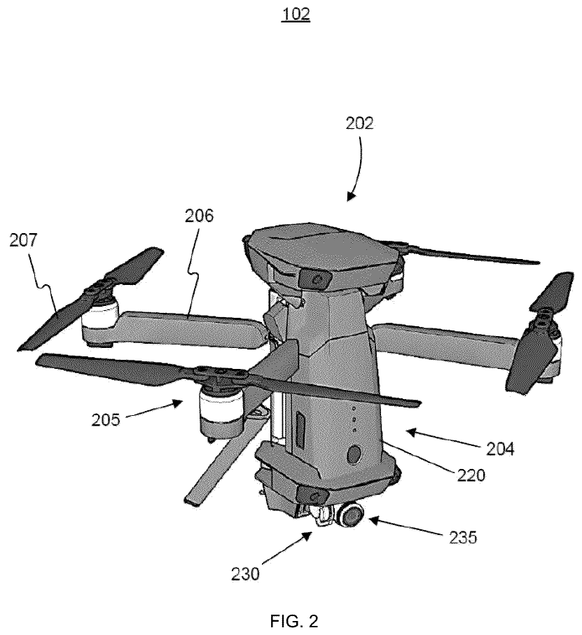

FIG. 1 shows an example system 100 of a movable object 102 and a corresponding operating environment, in accordance with some exemplary embodiments of the present disclosure. For example, movable object 102 can be a UAV (e.g., an FPV UAV). System 100 includes movable object 102 and other system components, such as a network 120, a server 110 (e.g., a cloud-based server), a remote controller 130, and a mobile device 140 (e.g., a smartphone, a tablet, a personal digital assistant, a virtual reality device, or an augmented reality device). In FIG. 1, movable object 102 is only diagrammatical with respect to its relationship with the corresponding operating environment in system 100. The structure of movable object 102 will be described in detail with reference to FIG. 2. Movable object 102 includes a first body capable of flying and a second body detachably attached to the first body. For example, the second body can be a gimbal stabilizer, as described in detail with reference to FIG. 2. Movable object 102 can include a sensing system 101, a controller 103 (e.g., a flight controller), a communication system 105, and other subsystems or components (not shown in FIG. 1).

In some exemplary embodiments, movable object 102 can communicatively couple to one or more electronic devices, including mobile device 140 and server 110, via network 120 in order to exchange information with one another or other additional devices and systems. Additionally, or alternatively, movable object 102 can communicatively couple to remote controller 130. In some exemplary embodiments, system 100 can include no remote controller when the second body is detachable from the first body, where the second body can be used as a remote controller when it is detached from the first body.

In some exemplary embodiments, network 120 can be any combination of wired and wireless local area network (LAN) or wide area network (WAN), such as an intranet, an extranet, and the internet. In some exemplary embodiments, network 120 can provide communications between one or more electronic devices, as discussed in the present disclosure. For example, movable object 102 can send data (e.g., image data or motion data) detected by one or more on-board sensors in real time during movement of movable object 102 via network 120 to other system components (e.g., remote controller 130, mobile device 140, or server 110) that are configured to process the data. In addition, the processed data or operation instructions can be communicated in real time among remote controller 130, mobile device 140, or cloud-based server 110 via network 120. Further, operation instructions can be transmitted from remote controller 130, mobile device 140, or cloud-based server 110 to movable object 102 in real time to control the flight of movable object 102 and components thereof via any combination of any suitable communication technique, such as a LAN, a WAN, the internet, a cloud environment, a telecommunication network (e.g., a cellular network), a Wi-Fi connection, a Bluetooth® connection, a radiofrequency (RF) connection, an infrared (IR) connection, or any other communication technique.

Sensing system 101 of movable object 102 can include one or more sensors associated with one or more components or other subsystems of movable object 102. For instance, sensing system 101 can include sensors for determining positional information, velocity information, or acceleration information relating to movable object 102 or its observing targets. In some exemplary embodiments, sensing system 101 can also include carrier sensors. Components of sensing system 101 can be configured to generate data and information for determining (e.g., by controller 103) additional information associated with movable object 102, its components, or its observing targets. Sensing system 101 can include one or more sensors for sensing one or more aspects of movement of movable object 102. For example, sensing system 101 can include sensory devices associated with a payload (described below in detail with reference to FIG. 2) or additional sensory devices, such as a positioning sensor for a positioning system (e.g., GPS, GLONASS, Galileo, Beidou, GAGAN, or RTK), a motion sensor, an inertial sensor (e.g., an inertial measurement unit (IMU) or a multi-IMU array), a proximity sensor, or an imaging sensor. Sensing system 101 can also include sensors configured to provide data or information relating to the surrounding environment, such as weather information (e.g., temperature, pressure, or humidity), a lighting condition (e.g., a light-source frequency), air constituents, or nearby obstacles (e.g., objects, structures, people, or vehicles).

Communication system 105 of movable object 102 can be configured to enable communication of data, information, commands, or other types of signals between controller 103 of movable object 102 and off-board devices 104 (e.g., including remote controller 130, mobile device 140, server 110, or any device not integrated with movable object 102). Off-board devices 104 are represented by an enclosed dotted line in FIG. 1. Communication system 105 can include one or more on-board components (e.g., receivers, transmitters, or transceivers) configured to send or receive signals via one-way or two-way communication. The on-board components of communication system 105 can be configured to communicate with off-board devices 104 via network 120. For example, communication system 105 can be configured to enable communication with off-board devices 104 for providing input for controlling movable object 102 during flight, such as from remote controller 130, mobile device 140, or both.

Controller 103 of movable object 102 can be configured to communicate with various components or subsystems of movable object 102, such as communication system 105 or sensing system 101. Controller 103 can also communicate with a positioning system to receive data from sensing system 101 to determine the location of movable object 102. Controller 103 can also communicate with other types of on-board devices (e.g., a barometer, an IMU, a transponder) or off-board devices 104 to obtain or determine positioning information and velocity information of movable object 102. Controller 103 can also provide control signals (e.g., pulse-width modulation signals) to one or more electronic speed controllers (ESCs) of movable object 102 for controlling one or more propulsion devices of movable object 102 and can thus control the movement of movable object 102.

Off-board devices 104, such as remote controller 130 or mobile device 140, can be configured to receive input, such as input from a user and communicate signals indicative of the input to controller 103. For example, the input can include a user manual input, a user speech input, a user gesture captured by sensing system 101 of movable object 102, or any other types of input generated by the user. Based on the input from the user, an off-board device (e.g., remote controller 130 or mobile device 140) can be configured to generate corresponding signals indicative of one or more types of information, such as control data (e.g., signals) for moving or manipulating movable object 102 (e.g., via propulsion devices) or its payload (e.g., a camera), or a carrier (e.g., a gimbal stabilizer). In some exemplary embodiments, the off-board device (e.g., remote controller 130, mobile device 140, or server 110) can also be configured to receive data and information from movable object 102, such as data collected by or associated with the payload and operational data relating to positional data, velocity data, acceleration data, sensory data, or any other type of data relating to movable object 102, its components, or its surrounding environment.

In some exemplary embodiments, remote controller 130 can include a physical user interface that can include one or more control modules, control mechanisms, or control elements, collectively referred to herein as “control modules,” such as physical sticks (e.g., joysticks), levers, switches, knobs, sliders, wheels, wearable apparatus, touchable display, or buttons configured to control flight parameters. Remote controller 130 can be specifically designed for single-hand operation, thereby making movable object 102 and its corresponding devices and components in system 100 more portable. For example, the display screen of remote controller 130 can be smaller, and the control module can be more compact to make it easier for single-hand operation.

In some exemplary embodiments, remote controller 130 can further include a display device 131 configured to display image information captured by sensing system 101, such as signals indicative of information or data relating to movements of movable object 102 or data (e.g., image data or video data) captured by movable object 102 (e.g., in conjunction with sensing system 101). In some exemplary embodiments, display device 131 can be a multifunctional display device (e.g., a touchscreen) configured to display information as well as receive user input. In some exemplary embodiments, display device 131 can provide an interactive graphical user interface (GUI) for receiving one or more user inputs.

In some exemplary embodiments, display device 131 can be an integral component (e.g., attached or fixed) of remote controller 130. In some exemplary embodiments, display device 131 can be electronically connectable to (or dis-connectable from) remote controller 130 (e.g., via a connection port or a wireless communication link) or otherwise connectable to remote controller 130 via a mounting device (e.g., by clamping, clipping, clasping, hooking, adhering, or any type of mounting means). In some exemplary embodiments, besides remote controller 130, display device 131 can be a display component of mobile device 140, server 110, a laptop computer, or any other device in system 100.

In some exemplary embodiments, mobile device 140 (e.g., a smartphone or a tablet) can additionally or alternatively function as remote controller 130. For example, mobile device 140 can be configured to work in conjunction with a computer application (e.g., an “app”) to provide an interactive GUI (e.g., on a touchscreen of mobile device 140) for displaying information received from movable object 102 and for receiving user inputs. For example, the GUI on mobile device 140 can include the one or more control modules, control mechanisms, or control elements, collectively referred to herein as “control modules,” as graphical or virtual elements, such as virtual physical sticks (e.g., joysticks), virtual levers, virtual switches, virtual knobs, virtual sliders, virtual wheels, or virtual buttons configured to control flight parameters. In some exemplary embodiments, the computer application on mobile device 140 can enable the user to edit the image data or video data. In some exemplary embodiments, the user can post the edited image data or video data directly or through the computer application to social media without transferring them to another device (e.g., a desktop computer). In some exemplary embodiments, the computer application on mobile device 140 can also enable the user to process the image data or the video data by using the computing power of server 110 through network 120.

In some exemplary embodiments, display device 131 of remote controller 130 or the screen of mobile device 140 can display one or more images received from movable object 102. In some exemplary embodiments, movable object 102 can also include a display device (not shown in FIG. 1) configured to display images captured by sensing system 101. In some exemplary embodiments, display device 131 of remote controller 130, the screen of mobile device 140, or the display device of movable object 102 can also include interactive means (e.g., a touchscreen) for the user to identify or select a portion of an image of interest to the user.

Off-board devices 104 can include server 110 communicatively coupled to network 120 for communicating information with remote controller 130, mobile device 140, or movable object 102. Server 110 can be configured to perform one or more functionalities or sub-functionalities in addition to or in combination with remote controller 130 or mobile device 140. Off-board devices 104 can include one or more communication devices, such as antennas or other devices configured to send or receive signals. Off-board devices 104 can also include one or more input devices configured to receive input from a user, generate an input signal communicable to controller 103 to process for operating movable object 102. In addition to flight control inputs, off-board devices 104 can be used to receive user inputs of other information, such as manual control settings, automated control settings, control assistance settings, or aerial photography settings. It is understood that different combinations or layouts of input devices for one or more of off-board devices 104 are possible and within the scope of this disclosure.

In some exemplary embodiments, one or more electronic devices (e.g., movable object 102, server 110, remote controller 130, or mobile device 140) as discussed with reference to FIG. 1 can include at least one processor and at least one storage medium (e.g., a non-transitory computer-readable medium) storing instructions. Each processor can include various types of processing devices. For example, each processor can include an integrated circuit, a microprocessor, a preprocessor (e.g., an image preprocessor), a microchip, a microcontroller, all or part of a graphics processing unit (GPU), a central processing unit (CPU), a support circuit, a digital signal processor (DSP), a field-programmable gate array (FPGA), an application-specific integrated circuit (ASIC), or any combination of devices for performing operation based on the instructions. As another example, each processor can include any type of single or multi-core processor.

In some exemplary embodiments, each processor can be categorized into either of two tiers (tier-one or tier-two) based on performance, capability, and specificity. In some exemplary embodiments, a tier-one processor can have more processing power and include a large variety of functionalities. The tier-one processor can include a combination of one or more comparatively more generalized processors and one or more comparatively more specialized processing units designed for high-performance digital and vision signal processing. For example, the one or more comparatively more generalized processors can include one or more DSPs, Advanced RISC Machines (ARM) processors, GPUs, or a combination thereof. In another example, the one or more comparatively more specialized processing units can include one or more convolutional neural network (CNN) based adaptive cruise controls (ACC), vision-based ACCs, image signal processors (ISP), or a combination thereof. In some exemplary embodiments, a tier-two processor can include one or more processors (e.g., ARM M7 processors) having more limited functionality than the tier-one processor and can have a lower performance in certain areas such as image signal processing.

The two-tier categorization is on a relative scale related to processor selection and arrangement with respect to movable object 102. Categorizing processors as tier-one, tier-two, or removed from the tiers can change with the development of technology, upgrades of products, and can vary depending on the desired capabilities of movable object 102 and purposes of the related components of movable object 102.

When executed, the instructions stored in the storage media of the electronic devices can configure the at least one processor to process data obtained from the electronic devices. The instructions can also configure the at least one processor to identify a body indication of an operator, including one or more stationary bodily poses, attitudes, or positions identified in an image or images, or body movements determined based on a plurality of images. In some exemplary embodiments, the instructions can also configure the at least one processor to determine user commands corresponding to the identified body gestures of the operator to control movable object 102. The electronic devices can be further configured to transmit (e.g., substantially in real time with the flight of movable object 102) the determined user commands to related controlling and propelling components of system 100 and movable object 102 for corresponding control and operations. In some exemplary embodiments, controller 103 can include at least one processor and at least one storage medium.

In some exemplary embodiments, the at least one storage medium of movable object 102 can store instructions that cause the at least one processor of movable object 102 to process data obtained from sensing system 101. In some exemplary embodiments, the instructions can cause the communication system 105 to transfer data and data processing instructions or commands to one or more other devices (e.g., server 110) in system 100 through network 120 for them to process the data. In some exemplary embodiments, the instructions to process the data can be based on user commands received from remote controller 130, mobile device 140, or any other devices or components in system 100. For example, the instructions can cause the at least one processor to automatically transmit image data to server 110 and apply one or more predetermined image filters based on predetermined rules to edit the image data, which can enable the user to post the image data on social media once received, thereby saving time on editing the image data. In some exemplary embodiments, the at least one processor can be placed in the first body (e.g., the fuselage) or the second body (e.g., the gimbal stabilizer), or both. In some exemplary embodiments, there can be a first processor in the first body and a second processor in the second body. For example, the first processor and the second processor can be tier-one processors, tier-two processors, or a combination thereof. In some exemplary embodiments, the at least one storage medium of movable object 102 can be placed the first body, the second bod, or both.

FIG. 2 illustrates an example movable object 102 including a first body 202 and a second body 204, consistent with some exemplary embodiments of this disclosure. First body 202 and second body 204 can conduct some operations individually and collectively. For example, first body 202 can fly individually without second body 204 or integrated with second body 204. First body 202 and second body 204 can also conduct some other operations collectively that they cannot conduct individually. For example, first body 202 and second body 204 can act collectively to achieve omnidirectional obstacle avoidance.

In some exemplary embodiments, first body 202 can include one or more components (e.g., imaging sensors) of sensing system 101. For example, the one or more imaging sensors can include photographic cameras, video cameras, infrared imaging devices, ultraviolet imaging devices, x-ray devices, ultrasonic imaging devices, radar devices, or any combination thereof. In some exemplary embodiments, first body 202 can include sensors for determining positional information, velocity information, and acceleration information relating to movable object 102 or its observing targets. First body 202 can also include sensors configured to provide data or information relating to the surrounding environment, such as weather information (e.g., temperature, pressure, or humidity), lighting conditions (e.g., light-source frequencies), air constituents, or nearby obstacles (e.g., objects, structures, people, or vehicles).

In some exemplary embodiments, when detached from first body 202, second body 204 can function individually as a ground unit (e.g., a device that a user can operate on the ground), such as a handheld gimbal stabilizer. In some exemplary embodiments, when detached from first body 202, second body 204 can function as a remote controller (e.g., remote controller 130) of first body 202. For example, a user can send commands to first body 202 through a user interface (not shown in FIG. 2) of second body 204.

In some exemplary embodiments, first body 202 and second body 204 can be detachably attached to each other through magnetic attraction, structural attaching mechanism (e.g., clamping or buckling), or a combination thereof. The physical interface between first body 202 and second body 204 can include a physical data interface for data exchange between first body 202 and second body 204. The physical interface and the data interface between first body 202 and second body 204 can be standardized or uniformized such that upgrades and changes to either or both of first body 202 and second body 204 do not affect the physical interface and the data interface.

In some exemplary embodiments, first body 202 can be disposed on top of second body 204, as shown in FIG. 2. In some other embodiments, second body 204 can be disposed on top of first body 202. In cases where second body 204 is disposed on top of first body 202, certain components can be disposed differently to optimize the functionality of movable object 102. For example, an imaging sensor associated with payload 235 can be omitted. Additional sensors can be disposed at the bottom of first body 202 to collect environmental data below movable object 102 during operation and while no sensors are disposed at the top of first body 202.

Data from different input interfaces and sensors, data of different types, and data for different uses by movable object 102 can be exchanged between first body 202 and second body 204 together or separately. For example, data gathered from the imaging sensor(s) associated with payload 235 of second body 204 for flight control can be exchanged via a separate channel from data gathered for image processing.

Movable object 102 can include one or more (e.g., 1, 2, 3, 4, 5, 10, 15, 20, or any number) propulsion devices 205 positioned at one or more locations (e.g., top, sides, front, rear, or bottom of movable object 102) for propelling and steering movable object 102, such as being positioned on one or more arms 206 coupled to first body 202. Propulsion devices 205 can include devices or systems operable to generate forces for sustaining controlled flight. Propulsion devices 205 can share, separately include, or be operatively connected to a power source (not shown in FIG. 2), such as a motor (e.g., an electric motor, hydraulic motor, or pneumatic motor), an engine (e.g., an internal combustion engine or a turbine engine), a battery bank, or a combination thereof. Each propulsion device 205 can also include one or more rotary components 207 (e.g., rotors, propellers, blades, or nozzles) drivably connected to the power source and configured to participate in the generation of forces for sustaining controlled flight. For instance, rotary components 207 can be driven on or by a shaft, axle, wheel, hydraulic system, pneumatic system, or any component or system configured to transfer power from the power source.

In some exemplary embodiments, propulsion devices 205 and rotary components 207 can be adjustable (e.g., tiltable) with respect to each other or with respect to movable object 102. Alternatively, propulsion devices 205 and rotary components 207 can have a fixed orientation with respect to each other or movable object 102. In some exemplary embodiments, each propulsion device 205 can be of the same type. In some exemplary embodiments, propulsion devices 205 can be of multiple different types. In some exemplary embodiments, all propulsion devices 205 can be controlled in concert (e.g., all at the same speed or angle). In other embodiments, one or more of propulsion devices 205 can be independently controlled (e.g., to have different speeds or angles).

Propulsion devices 205 can be configured to propel movable object 102 in one or more vertical and horizontal directions and to allow movable object 102 to rotate about one or more axes (e.g., a pitch axis, a roll axis, or a yaw axis). For example, propulsion devices 205 can operate to provide lift or thrust for creating and maintaining translational and rotational movements of movable object 102. For instance, propulsion devices 205 can be configured to enable movable object 102 to achieve and maintain desired altitudes, provide thrust for movement in all directions, and provide for steering of movable object 102. In some exemplary embodiments, propulsion devices 205 can enable movable object 102 to perform vertical takeoffs and landings (e.g., takeoff and landing without horizontal thrust). Propulsion devices 205 can be configured to enable movement of movable object 102 along or about multiple axes.

In some exemplary embodiments, payload 235 includes a sensory device (e.g., as part of sensing system 101). The sensory device can include devices for collecting or generating data or information, such as surveying, tracking, and capturing images or video of targets (e.g., objects, landscapes, or subjects of photo or video shoots). For example, the sensory device can include an imaging sensor configured to gather data that can be used to generate images. In some exemplary embodiments, image data obtained from the imaging sensor can be processed and analyzed to obtain commands and instructions from one or more users to operate movable object 102 or the imaging sensor. In some exemplary embodiments, the imaging sensor can include photographic cameras, video cameras, vision sensors (e.g., monocular or binocular cameras), infrared imaging devices, ultraviolet imaging devices, x-ray devices, ultrasonic imaging devices, radar devices, or any combination thereof. In some exemplary embodiments, the sensory device can additionally or alternatively include devices for capturing audio data, such as microphones or ultrasound detectors. In some exemplary embodiments, the sensory device can additionally or alternatively include other sensors for capturing visual, audio, or electromagnetic signals.

As illustrated in FIG. 2, movable object 102 can include a carrier 230 that can include one or more devices configured to hold payload 235 or allow payload 235 to be adjusted (e.g., rotated) with respect to movable object 102. For example, carrier 230 can be a gimbal. Carrier 230 can be configured to allow payload 235 to be rotated about one or more axes. In some exemplary embodiments, carrier 230 can be configured to allow payload 235 to rotate about an axis of each degree of freedom by 360° to allow for greater control of the perspective of payload 235. In some exemplary embodiments, carrier 230 can limit the range of rotation of payload 235 to less than 360° (e.g., ≤270°, ≤210°, ≤180, ≤120°, ≤90°, ≤45°, ≤30°, ≤15°, or below any angle) about one or more of its axes.

Carrier 230 can include a frame assembly (not illustrated in FIG. 2), one or more actuator members (not illustrated in FIG. 2), or one or more carrier sensors (not illustrated in FIG. 2). The frame assembly can be configured to couple payload 235 to movable object 102. In some exemplary embodiments, the frame assembly can allow payload 235 to move with respect to movable object 102. In some exemplary embodiments, the frame assembly can include one or more sub-frames or components movable with respect to each other.

The actuator members of carrier 230 can be configured to drive components of the frame assembly relative to each other to provide translational or rotational motion of payload 235 with respect to movable object 102. In other embodiments, the actuator members can be configured to directly act on payload 235 to cause motion of payload 235 with respect to the frame assembly and movable object 102. In some exemplary embodiments, the actuator members can include actuators or force transmission components. For example, the actuator members can include electric motors configured to provide linear or rotational motion to components of the frame assembly or payload 235 in conjunction with axles, shafts, rails, belts, chains, gears, or other components.

The carrier sensors of carrier 230 can include devices configured to measure, sense, detect, or determine state information of carrier 230 or payload 235. For example, the carrier sensors can include any combination of potentiometers, optical sensors, visions sensors, magnetic sensors, motion or rotation sensors (e.g., gyroscopes, accelerometers, or inertial sensors). State information in this disclosure can include positional information (e.g., relative location, orientation, attitude, linear displacement, or angular displacement), velocity information (e.g., a linear velocity or speed, or an angular velocity or speed), acceleration information (e.g., a linear acceleration or an angular acceleration), or any information relating to movement control (either independently or with respect to movable object 102) of carrier 230 or payload 235. In some exemplary embodiments, the carrier sensors can be associated with or attached to various components of carrier 230, such as components of the frame assembly or the actuator members, or to movable object 102 itself. In some exemplary embodiments, the carrier sensors can be configured to communicate data and information with controller 103 in FIG. 1 via a wired or wireless connection (e.g., an RFID, Bluetooth®, Wi-Fi, radio, or cellular connection). In some exemplary embodiments, data and information generated by the carrier sensors and communicated to controller 103 can be used by controller 103 for further processing, such as for determining state information of movable object 102 or targets.

In some exemplary embodiments, carrier 230 can be coupled to movable object 102 via one or more damping elements (not shown in FIG. 2) configured to reduce or eliminate undesired shock or other force transmissions to payload 235 from movable object 102. Damping elements can be active, passive, or hybrid (e.g., having active and passive characteristics). Damping elements can be formed of any material or combinations of materials, including solids, liquids, or gases. In some exemplary embodiments, compressible or deformable materials (e.g., rubber, springs, gels, foams, or other materials) can be used as damping elements. In some exemplary embodiments, the damping elements can function to isolate payload 235 from movable object 102 or dissipate force propagations from movable object 102 to payload 235. Damping elements can also include mechanisms or devices configured to provide damping effects, such as pistons, springs, hydraulics, pneumatics, dashpots, shock absorbers, or any combination thereof.

As illustrated in FIG. 2, movable object 102 can include a power storage device 220 that can be a device configured to power or otherwise supply power to electronic components or mechanical components in movable object 102. For example, power storage device 220 can include a battery, a battery bank, or any other device for storing electric power. In some exemplary embodiments, power storage device 220 can store non-electric power, such as a combustible fuel or a fuel cell. In some exemplary embodiments, power storage device 220 can power the one or more sensors on movable object 102. Power storage device 220 can also power first body 202 and components of first body 202 for conducting operations. For example, power storage device 220 can power first body 202 to fly by powering the propulsion devices 205 on the one or more arms 206 to actuate the one or more rotary components 207 to rotate. Power storage device 220 can power second body 204 and components of second body 204 for conducting operations. For example, power storage device 220 can power a user payload 235 on second body 204.

In some exemplary embodiments, movable object 102 can receive (e.g., from remote controller 130 or mobile device 140 illustrated in FIG. 1) one or more commands (or signals) that affect first body 202, second body 204, and other components or devices in system 100. For example, the commands can cause movable object 102 to conduct one or more automated missions.

For example, the commands can cause movable object 102 to take off, fly for a predetermined trajectory with respect to a predetermined target based on one or more predetermined parameters, determine that at least one ending condition is met, and land at the take-off location. In another example, the commands can cause movable object 102 to take off, fly for a predetermined trajectory based on one or more predetermined parameters, determine that at least one ending condition is met, and land at the take-off location. As another example, the commands can cause movable object 102 to take off, follow a predetermined target based on one or more predetermined parameters, determine that at least one ending condition is met, and land at a location with respect to the target based on one or more predetermined parameters.

In some exemplary embodiments, the at least one ending condition in the automated missions can be predetermined through a user input. In some exemplary embodiments, the at least one ending condition can include a loss of target, a predetermined amount of flying time, a predetermined flight length, a distance from the predetermined target, a completion of predetermined flight trajectory, an identification of a specific input from the user, or any combination thereof. For example, the trajectory can be a circle hovering around a target or a point with respect to a target, a spiral curve with increasing or decreasing distance from an axis, a line along which movable object 102 can move and pause, or any combination thereof. In some exemplary embodiments, the one or more predetermined parameters that the predetermined trajectory is based on can be the distance from the axis or the target, flight speed related parameters (e.g., speed limit, average speed, or acceleration), height related parameters, the timing of pause and hovering during the flight, or any combination thereof.

It should be noted that the commands can cause movable object 102 to perform conduct various automated missions that can include various ending conditions or predetermined parameters, and this disclosure does not limit the automated missions to the exemplary embodiments as described herein.

In some exemplary embodiments, movable object 102 can conduct one or more missions during flight based on the commands. For example, the missions can include taking image(s) or video(s) of at least one predetermined target, taking image(s) or video(s) of environment, taking image(s) or video(s) with one or more effects (e.g., zooming in, zooming out, time lapse, or slow motion), gathering data through sensing system 101, or any combination thereof.

In some exemplary embodiments, before taking off for a flight, movable object 102 can conduct an automated self-inspection and environmental inspection. The automated self-inspection can include checking a plurality of conditions of movable object 102 that can affect the flight, such as a remaining battery level, conditions of subsystems and components of system 100, data about movable object 102 from sensing system 101, connection to network 120, or any combination thereof. Environmental inspection can include checking a plurality of conditions of the surrounding environment that can affect the flight, such as weather information (e.g., temperature, pressure, or humidity), lighting conditions (e.g., light-source frequencies), air constituents, or nearby obstacles (e.g., objects, structures, people, or vehicles). In some exemplary embodiments, environmental inspection can further include determining whether the environment is suitable for taking off. For example, system 100 can determine whether the environment is suitable for taking off based on stability and levelness of the platform that movable object 102 is placed on, or the height and density of nearby obstacles. In some exemplary embodiments, placing movable object 102 on the ground is a preferred condition for taking off. In some exemplary embodiments, movable object 102 can wait for a predetermined period of time after getting ready to take off, which can give the user some time to walk away or prepare to conduct some other tasks.

In some exemplary embodiments, the commands can cause movable object 102 to take off in a “paper plane” mode. In the paper plane mode, movable object 102 can start conducting one or more missions after the user launches movable object 102 by throwing it. After selecting a user command of paper plane mode, the user can further select one or more predetermined parameters or give other user command(s) related to one or more missions. Then the user can launch movable object 102 by throwing to enable movable object 102 to start. After receiving the user command of paper plane mode, system 100 can detect an event that movable object 102 is being thrown based on data received from one or more components of sensing system 101 (e.g., inertial sensors, motion sensors, proximity sensors, or positioning sensors), and calculation based on the data.

In some exemplary embodiments, movable object 102 can conduct obstacle avoidance using one or more components (e.g., vision sensors) of sensing system 101. For example, movable object 102 can use vision sensors to obtain vision data relating to the surrounding environment. Omnidirectional obstacle avoidance can be achieved with vision sensors having a limited field of view (FOV), a wide-angle FOV, a fisheye FOV, or a combination thereof to obtain the vision data relating to the surrounding environment. In some exemplary embodiments, the imaging sensors can be positioned in one or more sides (e.g., front, rear, left, right, top, or bottom) of movable object 102 (e.g., on first body 202, second body 204, or both).

In some exemplary embodiments, the vision sensors can be used to capture images at a specified frequency to produce a time series of image data. The time series of image data can be processed to determine the position, orientation, or velocity of movable object 102 using any method (e.g., a machine-learning based vision algorithm). For example, the machine-learning based vision algorithm can be used to identify one or more feature points within each image (e.g., an edge of an object, a corner of an object, or a boundary between objects of two different colors) and provide a digital representation of the feature points. For example, the digital representation of the feature points can be determined using a features from accelerated segment test (FAST) algorithm or a binary robust independent elementary features (BRIEF) algorithm. The image data can then be matched to each other to identify a set of common feature points appearing in images obtained by the vision sensors. The motion of the movable object 102 can be determined based on the common feature points and the spatial disposition of the vision sensors relative to the movable object 102 and to each other.

Aspects of this disclosure can provide a technical solution to the challenging technical problem of flight control of a movable object, including methods, systems, devices, and computer-readable media. For ease of discussion, example methods are described below with the understanding that aspects of the example methods apply equally to systems, devices, and computer-readable media. For example, some aspects of such methods can be implemented by a computing device or software running thereon. The computing device can include a processor (e.g., a CPU, GPU, DSP, FPGA, ASIC, or any circuitry for performing logical operations on input data) to perform the example methods. In some embodiment, the processor can include one or more processors integrated in at least one of the movable object or an apparatus (e.g., a remote controller, a mobile device, or a server computer) communicatively coupled to the movable object. Other aspects of such methods can be implemented over a network (e.g., a wired network, a wireless network, or both).

As another example, some aspects of such methods can be implemented as operations or program codes in a non-transitory computer-readable medium. The operations or program codes can be executed by a processor. Non-transitory computer readable mediums, as described herein, can be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather can be accomplished using many differing instrumentalities.

Some aspects of this disclosure can provide a technical solution to control horizontal speed of the movable object. Consistent with some exemplary embodiments of this disclosure, a processor associated with the movable object can perform operations of receiving a parameter value (e.g., representing a pitch angle) from a user interface communicatively coupled to the movable object. The “receiving,” as used herein, can refer to accepting, taking in, admitting, gaining, acquiring, retrieving, obtaining, reading, accessing, collecting, or any operation for inputting. The parameter value can be a first parameter value. The “first parameter value” in this disclosure can include a parameter value for controlling a position or posture of the movable object with respect to a pitch axis of the movable object. While the first parameter has been disclosed herein as corresponding to a particular parameter value, the disclosure is not so limited. Embodiments can be practiced with equal effectiveness utilizing another parameter as the first parameter that facilitates control of the movable object. The “pitch axis” of the movable object in this disclosure refers to an axis laterally crossing the gravity center of the movable object and being perpendicular to a moving direction of the movable object. For example, the pitch axis can be an axis crossing the movable object from its left side to its right side, viewed from above. The moving direction of the movable object can be a tangential direction of its trajectory. A “pitch angle” in this disclosure refers to an angle between the moving direction of the movable object and a longitudinal axis of the movable object, viewed along the pitch axis. The “longitudinal axis” of the movable object, as used herein, refers to an axis of symmetry crossing the gravity center of the movable object in a nose-to-tail direction.

A “user interface” in this disclosure can include any physical or graphical interface for a user to interact with purporting to display information or receive input data. For example, the user interface may include a physical controller (e.g., a wireless remote controller), or a graphical user interface of a software controlling program displayed on a screen of a device (e.g., a smartphone, a tablet computer, or any computing device). In some exemplary embodiments, the user interface may include one or more control modules (e.g., joysticks, wheels, buttons, switches, or any type of physical or graphical modules) for controlling one or more parameters of the movable object. The “movable object” in this disclosure can include any object or platform that can move in a three-dimensional space. For example, the movable object can be a UAV (e.g., an FPV UAV). A processor associated with the movable object in this disclosure can include a processor of the movable object (e.g., a processor integrated inside movable object) or a processor of a device (e.g., remote controller 130) associated with (e.g., being paired with) the movable object.

In some exemplary embodiments, the user interface can be physically integrated as part of the movable object. In some exemplary embodiments, the user interface can be detached from the movable object, such as being integrated as part of a remote controller that can communicate with the movable object. In some exemplary embodiments, the user interface can be communicatively coupled to the movable object via a wireless network.

In some exemplary embodiments, the user interface can include a physical user interface on a remote controller or a GUI on a screen. A “physical user interface” in this disclosure can refer to any physical components, objects, elements, or modules installed on a physical device for enabling a user to interact. A “remote controller” in this disclosure can refer to a controller communicatively coupled to the movable object via a communication technique (e.g., a wireless network).

By way of example, the movable object and the remote controller can be movable object 102 and remote controller 130 in FIG. 1, respectively. The processor can include controller 103 of movable object 102, a processor of mobile device 140 in FIG. 1, a processor of server 110, a processor of remote controller 130 or a combination thereof. In an example, the user interface can be a physical user interface of remote controller 130. In another example, the user interface can be a GUI on a screen (e.g., a touchscreen) of display device 131 or mobile device 140 in FIG. 1. In some exemplary embodiments, if the processor is controller 103, controller 103 can receive the pitch control parameter via communication system 105. By way of example, the wireless network can be network 120 in FIG. 1.

In some exemplary embodiments, the user interface can include a control module that includes a movable part having a neutral position. A “control module” in this disclosure can refer to any physical or graphical object for controlling. A “movable part” of the control module can include a part that can be moved with respect to other parts of the control module under manipulation. A “neutral position” of the movable part can include a default position where the movable part rests or returns to without manipulation. In some exemplary embodiments, the control module can include a physical or virtual stick (e.g., a joystick), a physical or virtual knob, a physical or virtual slider, a physical or virtual wheel, a physical or virtual lever, a physical or virtual switch, or any combination thereof. For example, if the control module is a physical or virtual joystick, the movable part can be a control column or lever of the joystick, and the neutral position can be where the control column stays or returns without manipulation. In some exemplary embodiments, the control module can be configured to control at least one of the pitch angle of the movable object or a horizontal speed of the movable object. A “horizontal speed” of the movable object in this disclosure refers to a speed of the movable object along a horizontal direction (e.g., to the left, right, forward, backward, or any combination thereof).

In some exemplary embodiments, to receive the first parameter value from the user interface, the processor can perform operations of receiving the first parameter value from the control module. The first parameter value can represent a displacement of the movable part from the neutral position in a direction. For example, if the control module is a physical or virtual joystick, the displacement of the movable part from the neutral position in the direction can be a deflection of the control column of the joystick from the neutral position in a direction (e.g., to the left, right, forward, backward, or any combination thereof). As another example, if the control module is a physical or virtual wheel, the displacement of the movable part from the neutral position in the direction can be a rotation angle of the wheel from the neutral position (e.g., a zero position) in a direction (e.g., to the left, right, forward, backward, or any combination thereof). In another example, if the control module is a physical or virtual button, the displacement of the movable part from the neutral position in the direction can be a pressure value applied onto the button in a pressing direction, in which the neutral position can be a position of the button with no pressure applied thereto. In another example, if the control module is a physical or virtual button, the displacement of the movable part from the neutral position in the direction can be a time duration of a press applied onto the button in the pressing direction, in which the neutral position can be a predetermined time duration (e.g., 5 milliseconds, 10 milliseconds, 100 milliseconds, 1 second, 2 seconds, or any predetermined time length) of the press. In the above-described examples, the pitch control parameter value can have a mapping relationship (e.g., a one-to-one relationship) with such a deflection (if the control module is a physical or virtual joystick), rotation angle (if the control module is a physical or virtual wheel), pressure value (if the control module is a physical or virtual button), or time duration of the press (if the control module is a physical or virtual button).

Consistent with some exemplary embodiments of this disclosure, the processor can also perform operations of determining a horizontal acceleration based on the first parameter value. The horizontal acceleration can be substantially zero (e.g., within a range of ±1 cm/s2) when the first parameter value is zero. For example, when the first parameter value is zero, it can represent that no control is applied to the pitch angle (e.g., when a user releases control on the user interface). A “horizontal acceleration” in this disclosure can refer to a positive or negative acceleration value in a horizontal direction (e.g., to the left, right, forward, backward, or any combination thereof). In some exemplary embodiments, the horizontal acceleration can have a mapping relationship (e.g., a positive correlation or a proportional relationship) with the first parameter value.

In some exemplary embodiments, the horizontal acceleration can have a mapping relationship (e.g., a one-to-one relationship) with the displacement of the movable part of the control module from the neutral position. To determine the horizontal acceleration, in some exemplary embodiments, the processor can perform operations of determining the horizontal acceleration as positive when the direction is a first direction. For example, if the control module is a physical or virtual joystick, the first direction to which the control column of the joystick deflects can be a forward direction. In such an example, the processor can determine the horizontal acceleration as positive (e.g., effectuating to increase a speed of the movable object along its moving direction).

In some exemplary embodiments, to determine the horizontal acceleration, the processor can perform operations of determining the horizontal acceleration as substantially zero (e.g., being within a range of ±1 cm/s2) when the first parameter value represents that the movable part is at the neutral position. For example, if the control module is a physical or virtual joystick and no manipulation is exerted on the control column of the joystick (e.g., when a user no longer touches the control column), the control column stays or returns to the neutral position, and the pitch control parameter value has a corresponding value (e.g., “0”). In such an example, the least one processor can determine the horizontal acceleration as substantially zero, in which the movable object can maintain its current horizontal speed (i.e., neither accelerate nor decelerate). If the current horizontal speed of the movable object is non-zero, the movable object can coast or cruise along its moving direction at the current horizontal speed.

In some exemplary embodiments, to determine the horizontal acceleration, the processor can perform operations of determining the horizontal acceleration as negative when the direction is a second direction different from the first direction. For example, if the control module is a physical or virtual joystick and the first direction is a forward direction, the second direction can be a backward direction to which the control column of the joystick deflects. In such an example, the processor can determine the horizontal acceleration as negative (e.g., effectuating to decrease a speed of the movable object along its moving direction). That is, in such an example, the horizontal acceleration can decelerate the movable object along its moving direction. In some exemplary embodiments, the processor can control the movable object to stop when the negative horizontal acceleration decelerates the movable object to a substantially zero speed (e.g., being within a range of ±1 cm/s). In some exemplary embodiments, after the movable object stops, the processor can control the movable object to re-accelerate along a direction opposite to the moving direction of the movable object before it stops.

In some exemplary embodiments, when the direction is the second direction, the processor can determine the horizontal acceleration to have different negative values based on conditions. For example, the processor can determine whether the first parameter value exceeds a threshold value (e.g., when the control column of the joystick is deflected in the second direction exceeding a threshold deflection amount if the control module is a physical or virtual joystick). In response to the first parameter value not exceeding the threshold value, the processor can determine the horizontal acceleration is a negative value corresponding to the first parameter value. For example, if the horizontal acceleration has a first mapping relationship (e.g., a one-to-one relationship) with the pitch control parameter value and the pitch control parameter value has a second mapping relationship (e.g., a one-to-one relationship) with the displacement of the movable part of the control module from the neutral position, the processor can determine the horizontal acceleration as the negative value in accordance with the first and second mapping relationships.

In response to the first parameter value exceeding the threshold value, the processor can determine the horizontal acceleration is a negative value corresponding to a maximum displacement in the second direction. For example, if the control module is a physical or virtual joystick and the control column of the joystick is deflected in the second direction exceeding the threshold deflection amount, the processor can determine the horizontal acceleration as the maximum negative value allowed by the first and second mapping relationships. By doing so, when a user displaces the movable part of the control module from the neutral position exceeding a threshold position, the first parameter value can exceed the threshold value, and the processor can determine that the user wants to apply a quick brake, and thus determine the horizontal acceleration to be the maximum allowable negative value. In some exemplary embodiments, the processor can determine the horizontal acceleration as substantially zero (e.g., being within a range of ±1 cm/s2) in response to the movable object stopping (e.g., moving at a substantially zero speed, such as being within a range of ±1 cm/s) in the second direction. For example, the negative horizontal acceleration can decelerate the movable object in the second direction, and by setting the horizontal acceleration as substantially zero when the movable object stops in the second direction, the movable object can remain stopped (e.g., at substantially zero speed not accelerating in reverse).

Consistent with some exemplary embodiments of this disclosure, the processor can further perform operations of controlling the movable object to accelerate or decelerate in accordance with the determined horizontal acceleration. By way of example, with reference to FIG. 2, the processor can control operations (e.g., by changing tilting angles or rotating speeds) of any combination of propulsion devices 205, arms 206, and rotary components 207 to accelerate or decelerate movable object 102 in accordance with the horizontal acceleration.

Consistent with some exemplary embodiments of this disclosure, in addition to determining the horizontal acceleration based on the first parameter value, the processor can further perform operations of determining a horizontal speed limit based on the first parameter value. A “horizontal speed limit” in this disclosure refers to a limit on a speed of the movable object along a horizontal direction (e.g., to the left, right, forward, backward, or any combination thereof). For example, when the movable part of the control module of the user interface has a displacement in the first direction (e.g., a forward direction) from the neutral position exceeding a first threshold displacement value, the horizontal speed limit has a maximum positive value in the moving direction of the movable object. In such a case, even if the displacement of the movable part increases, the movable object will not be further accelerated. In some exemplary embodiments, the processor can adjust the first threshold displacement value or the maximum positive value of the horizontal speed limit based on user input data.

In another example, when the movable part of the control module has a displacement in the second direction (e.g., a backward direction) from the neutral position exceeding a second threshold displacement value, the horizontal speed limit has a minimum non-zero positive value in the moving direction of the movable object. In such a case, even if the displacement of the movable part is still in the second direction, the movable object will maintain a non-zero speed along its the moving direction.

As another example, when the movable part of the control module has a maximum displacement in the second direction (e.g., a backward direction) from the neutral position, the horizontal speed limit has a substantially zero value (e.g., being within a range of ±1 cm/s). In such a case, the movable object reduces its horizontal speed to stop in the horizontal direction.

In some exemplary embodiments, after the movable object reaches a substantially zero speed (e.g., being within a range of ±1 cm/s), if the movable part of the control module has a displacement in the second direction, the horizontal speed limit can have a non-zero value in a new direction (e.g., a direction opposite to the moving direction of the movable object before it stops). In such a case, the movable object can be accelerated along the new direction. In some exemplary embodiments, the horizontal speed limit can have a mapping relationship (e.g., a positive correlation or a proportional relationship) with the first parameter value. In such cases, the horizontal speed limit is not a fixed value and can have different values corresponding to different first parameter values.

In some exemplary embodiments, to control the movable object or accelerate or decelerate after determining the horizontal speed limit, the processor can perform operations of controlling the movable object to accelerate in accordance with the horizontal acceleration when the horizontal acceleration is positive and a horizontal speed of the movable object is below the horizontal speed limit. The processor can also perform operations of controlling the movable object to decelerate in accordance with the horizontal acceleration when the horizontal acceleration is negative and the horizontal speed of the movable object is above the horizontal speed limit. In some exemplary embodiments, when the movable object is accelerated or decelerated to move at the horizontal speed limit, the processor can control accelerating or decelerating the movable object to stop at a substantially zero speed (e.g., being within a range of ±1 cm/s) in the horizontal direction. For example, the processor can control the movable object to decelerate to stop at a substantially zero speed (e.g., being within a range of ±1 cm/s) in a moving direction of the movable object.

In some exemplary embodiments, when the movable object is decelerated to stop and the speed limit has a non-zero value in the above-described new direction, the processor can control the movable object to accelerate to reach the speed limit in the new direction. In some exemplary embodiments, the processor can receive a resetting signal from the user interface and control, in response to the resetting signal, the movable object to accelerate in a direction opposite to the moving direction (e.g., a backward direction) in accordance with the horizontal acceleration. For example, the resetting signal can be generated by triggering (e.g., pressing, tapping, pushing, double clicking, triple clicking, or any combination of actions for activating) a device (e.g., a button, a switch, or any controlling device) on the user interface. In another example, the resetting signal can be generated by releasing the movable part of the control module to let it return to the neutral position. In some exemplary embodiments, after controlling the movable object to accelerate in the direction opposite to the moving direction, the processor can further activate a vision sensor communicatively coupled to the movable object, where the vision sensor faces the direction opposite to the moving direction. By way of example, the vision sensor can be the vision sensor as described in association with FIGS. 1-2. By doing so, the movable object can generate imaging data (e.g., for obstacle avoidance, photo shooting, or video shooting) in the new direction without rotating its head or tail.

Consistent with some exemplary embodiments of this disclosure, the technical solution to controlling horizontal speed of the movable object can include different modes of speed controlling. In some exemplary embodiments, the processor can further perform an operation of determining a value of a mode signal representing a first mode or a second mode. In response to the mode signal representing the first mode, the processor can perform operations of controlling the movable object to accelerate or decelerate in accordance with the horizontal acceleration. In response to the mode signal representing the second mode, the processor can perform operations of determining a horizontal target speed based on the first parameter value, and controlling the movable object to move at a horizontal target speed. A “horizontal target speed” in this disclosure refers to a horizontal speed set as a target for the movable object to reach. For example, in the second mode, the processor maps the first parameter value to the horizontal target speed instead of the horizontal acceleration and controls the movable object to accelerate or decelerate in a constant or non-constant acceleration to reach the horizontal target speed. In some exemplary embodiments, the first mode can be more suitable for photo or video shooting in a wide open environment (e.g., outdoor), and the second mode can be more suitable for controlling the movable object to take off or land.

In some exemplary embodiments, to determine a value of the mode signal, the processor can receive the mode signal from a mode selection module (e.g., a switch, a button, a slider, a wheel, or any physical or virtual module for making selections) of the user interface. In some exemplary embodiments, the processor determines the value of the mode signal in response to a sensing system communicatively coupled to the processor receiving data representing a predetermined condition. The predetermined condition can include at least one of a condition of the movable object moving at a speed (e.g., a speed in any direction) below a predetermined speed limit (e.g., a speed limit in any direction) or a condition that an altitude (e.g., a height above the ground) of the movable object is below a predetermined altitude limit (e.g., during taking off or landing). For example, when the movable object is moving at a low speed or when the movable object is taking off or landing, the processor can automatically generate the mode signal without any user interaction. By way of example, the sensing system can be sensing system 101 as illustrated in FIG. 1.

Consistent with some exemplary embodiments of this disclosure, the movable object can couple to a camera. By way of example, the camera can be payload 235 as illustrated and described with reference to FIG. 2. In some exemplary embodiments, the processor can further perform operations of determining a camera pitch angle based on the first parameter value and controlling the camera coupled to the movable object to point downward by the camera pitch angle when the movable object accelerates. A “camera pitch angle,” as used herein, refers to a pitch angle of the camera. The pitch angle of the camera can singly depend on a pitch angle of the camera body, singly depend on a pitch angle of a carrier (e.g., a gimbal) carrying (e.g., by a screw, a clamp, glue, or any fixtures) the camera body, or combinedly depend on the pitch angle of the camera body and the pitch angle of the carrier. In some exemplary embodiments, the camera pitch angle can have a mapping relationship (e.g., a one-to-one relationship) with the horizontal acceleration. For example, the mapping relationship can be a positive correlation (e.g., a proportional relationship), in which the camera pitch angle increases when the horizontal acceleration of the movable object increases. In another example, the camera pitch angle can have the mapping relationship with the horizontal acceleration that further has a mapping relationship with the displacement of the moving part of the control module from the neutral position. By doing so, the downward pointing camera can generate a video feed that provide a FOV visual experience of accelerating, thus providing excitement to the user of the movable object. In addition, the downward pointing camera can generate an angular momentum to cancel vibration of the movable object caused by the acceleration. In some exemplary embodiments, after the movable object stops accelerating (e.g., reaching a horizontal speed limit), the processor can control the camera to point upward by the camera pitch angle such that the camera can restore its previous orientation angle before the movable object being accelerated.

In some exemplary embodiments, to control the camera to point downward by the camera pitch angle, the processor can further perform operations of adjusting a carrier (e.g., a gimbal) coupled to the movable object and the camera to cause the camera to point downward by the camera pitch angle when the movable object accelerates. By way of example, the carrier can be carrier 230 as illustrated and described with reference to FIG. 2.

The technical solution to control horizontal speed of the movable object as described above can map the first parameter value to a horizontal acceleration instead of a horizontal target speed in accordance with a mapping relationship (e.g., a one-to-one relationship). When a user of the movable object releases the movable part (e.g., a control column) of the control module (e.g., a physical or virtual joystick) of the user interface to let the movable part return to the neutral position, the horizontal acceleration can be set as substantially zero (e.g., being within a range of ±1 cm/s2), and the horizontal speed of the movable object can be maintained constant. By doing so, the user can control the horizontal speed of the movable object with higher precision without special effort to maintain a preferable horizontal speed. Also, in some exemplary embodiments, the first parameter value can be additionally mapped to a horizontal speed limit in accordance with a mapping relationship (e.g., a one-to-one relationship). By doing so, the user can control the movable object with higher safety margin to avoid collision due to over speeding.

Besides horizontal speed control, some aspects of this disclosure can provide a technical solution to control turning of the movable object. For example, with reference to FIGS. 1-2, a user can control turning of movable object 102 by sending a signal indicative of a yaw angular speed to movable object 102 from a user interface (e.g., implemented on remote controller 130 or mobile device 140).

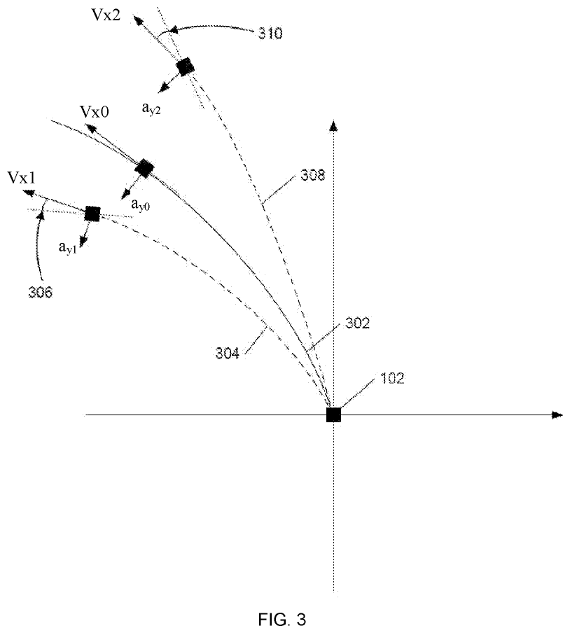

By way of example, FIG. 3 illustrates example paths of a movable object making turns, consistent with some exemplary embodiments of this disclosure. In FIG. 3, movable object 102 is represented by a black square. If movable object 102 receives (e.g., via communication system 105 illustrated in FIG. 1) only the signal indicative of a yaw angular speed, movable object 102 can make a turn following a path 302 (represented as a solid line curve), where a tangential speed of movable object 102 is represented as vₓ₀, and a lateral acceleration (e.g., an angular acceleration) of movable object 102 is represented as a_{y0}. The direction of a_{y0} can be perpendicular to vₓ₀. In such a situation, a longitudinal axis of movable object 102 (represented as a dotted line tangential to path 302) can be parallel to vₓ₀.

If movable object 102 receives the signal indicative of the yaw angular speed and a first signal indicative of a first roll angle, movable object 102 can make a skidding turn (referred to as “skidding”) following a path 304 (represented as a dashed curve), where a tangential speed of movable object 102 is represented as vₓ₁, and a lateral acceleration (e.g., an angular acceleration) of movable object 102 is represented as a_{y1}. The direction of a_{y1} can be perpendicular to vₓ₁. In such a situation, the longitudinal axis of movable object 102 (represented as a dotted line crossing path 304) can have a skid angle 306 with respect to vₓ₁ in the inside of path 304. For example, looking toward the direction of vₓ₀, if the first signal is for controlling to rotate movable object 102 (e.g., for the first roll angle), then movable object 102 will make the skidding turn following path 304.

If movable object 102 receives the signal indicative of the yaw angular speed and a second signal indicative of a second roll angle, movable object 102 can make a slipping turn (referred to as “slipping”) following a path 308 (represented as a dashed curve), where a tangential speed of movable object 102 is represented as vₓ₂, and a lateral acceleration (e.g., an angular acceleration) of movable object 102 is represented as a_{y2}. The direction of a_{y2} can be perpendicular to vₓ₂. In such a situation, the longitudinal axis of movable object 102 (represented as a dotted line crossing path 308) can have a slip angle 310 with respect to vₓ₂ in the outside of path 308. For example, looking toward the direction of vₓ₀, if the second signal is for controlling to rotate movable object 102 (e.g., for the second roll angle), then movable object 102 will make the slipping turn following path 308.

By receiving signals indicative of various combinations of yaw angular speeds and roll angles, movable object 102 can make various banked turns. A “banked turn,” as used herein, can refer to a turn of a movable object in which the movable object banks or inclines towards the inside of the turn. The banked turn can include a skidding turn (as illustrated by path 304), a slipping turn (as illustrated by path 308), or a coordinated turn (as illustrated by path 302) where no skidding or slipping occurs. By controlling movable object 102 to make various banked turns, movable object 102 can move with higher agility and flexibility.

However, movable object 102 can experience a jerking motion if a user manipulates the user interface (e.g., implemented on remote controller 130 or mobile device 140) to suddenly input a yaw angular speed or roll angle, which can cause jitter in a video feed captured by a camera (e.g., payload 235 in FIG. 2) coupled to movable object 102. This technical problem can exist in existing UAVs because they typically do not utilize feedback speed data of a UAV for controlling the speed of the UAV, especially in a situation where the UAV turns in a strong crosswind.

To solve such a technical problem, consistent with some exemplary embodiments of this disclosure, the processor associated with the movable object can perform operations of receiving (e.g., from a user interface communicatively coupled to the movable object) a second parameter value (also referred to herein as a “yaw angular speed parameter value”) and a third parameter value (also referred to herein as a “optional parameter value”). The second parameter value represents a yaw angular speed. In some exemplary embodiments, the third parameter value can represent a roll angle (e.g., inputted by a user from the user interface, or generated by the processor associated with the movable object without user intervention). The “second parameter value” in this disclosure can include a parameter value for controlling a position or posture of the movable object with respect to a yaw axis of the movable object. While the second parameter has been disclosed herein as corresponding to a particular parameter value, the disclosure is not so limited. Embodiments can be practiced with equal effectiveness utilizing another parameter as the second parameter that facilitates control of the movable object. The “yaw axis” of the movable object in this disclosure refers to an axis vertically crossing the gravity center of the movable object and being perpendicular to a moving direction of the movable object. The yaw axis is perpendicular to both the moving direction and the pitch axis. For example, the yaw axis can be an axis crossing the movable object from its top to its bottom, viewed from its side. A “yaw angle” in this disclosure refers to an angle between the moving direction of the movable object and the longitudinal axis of the movable object, viewed along the yaw axis. An “angular speed” in this disclosure refers to a rate at which the movable object changes its angle with respect to a rotation axis of a circular motion (e.g., the banked turn) in a given time period. A “yaw angular speed” in this disclosure refers to an angular speed about the yaw axis. A “roll angle” in this disclosure refers to an angle by which the movable object rotates about its longitudinal axis, viewed along a roll axis of the movable object. The “roll axis” of the movable object in this disclosure refers to an axis longitudinally (e.g., from nose to tail) crossing the gravity center of the movable object and being parallel to a moving direction of the movable object. For example, the roll axis of the movable object can be the longitudinal axis of the movable object. A “third parameter value” in this disclosure includes a parameter value for controlling a position or posture of the movable object with respect to the roll axis (e.g., a longitudinal axis) of the movable object. While the third parameter has been disclosed herein as corresponding to a particular parameter value, the disclosure is not so limited. Embodiments can be practiced with equal effectiveness utilizing another parameter as the third parameter that facilitates control of the movable object.

In some exemplary embodiments, the user interface can include a first control module (e.g., a first joystick) that includes a first movable part (e.g., a first control column) having a first neutral position. The user interface can also include a second control module (e.g., a second joystick) that includes a second movable part (e.g., a second control column) having a second neutral position. In some exemplary embodiments, the processor associated with the movable object can perform operations of receiving the second parameter value (i.e., the yaw angular speed parameter value) from the first control module of the user interface and receiving the third parameter value (i.e., the optional parameter value) from the second control module of the user interface.

Consistent with some exemplary embodiments of this disclosure, the processor can also perform operations of determining a horizontal speed of the movable object based on data of a sensing system communicatively coupled to the processor. In some exemplary embodiments, the horizontal speed of the movable object can be a tangential speed of the movable object in a horizontal direction when making a coordinated turn. In some exemplary embodiments, the data of the sensing system can include positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object.

By way of example, the sensing system can be sensing system 101 as illustrated and described in association with FIGS. 1-2. By way of example, the horizontal speed can be vₓ₀ as illustrated in FIG. 3.

Consistent with some exemplary embodiments of this disclosure, the processor can further perform operations of determining the roll angle based on the yaw angular speed, the horizontal speed, and the third parameter value (i.e., the optional parameter value). In some exemplary embodiments, to determine the roll angle, the processor can perform operations of determining the yaw angular speed based on an input yaw angle (e.g., inputted by a user from the user interface), determining a centripetal acceleration based on the yaw angular speed and the horizontal speed, and determining the roll angle based on the centripetal acceleration and the third parameter value, in which the third parameter value can represent a user-input roll angle. A “centripetal acceleration” in this disclosure refers to an angular acceleration of the movable object in a direction perpendicular to the moving direction of the movable object. In some exemplary embodiments, the centripetal acceleration can be a centripetal acceleration when the movable object makes a coordinated turn.

By way of example, the centripetal acceleration is a_{y0} as illustrated in FIG. 3. By way of example, if the input yaw angle and the horizontal speed are represented as ψᵤₛₑᵣ and vₓ, respectively, the yaw angular speed (represented as ω_{cmd}) and the centripetal acceleration (represented as a_{y}) can be determined based on Eqs. (1) to (2):

$${ω}_{cmd} = {f}_{rc} ( {ψ}_{user} ) \qquad Eq . ( 1 )$$

$${a}_{y} = {v}_{x} \cdot {ω}_{cmd} \qquad Eq . ( 2 )$$

where f_{rc}(⋅) represents a mapping (e.g., a linear or non-linear function) between the input yaw angle ψᵤₛₑᵣ and the yaw angular speed ω_{cmd}. The dot within the parenthesis of a function (e.g., f_{rc}(⋅)), or within parentheses of other functions as described hereinafter, represents a placeholder for an independent variable (e.g., ψᵤₛₑᵣ) of the function.

In some exemplary embodiments, to determine the centripetal acceleration, the processor can perform operations of determining a filtered yaw angular speed by applying a first low-pass filter to the yaw angular speed, and determining the centripetal acceleration based on the filtered yaw angular speed and the horizontal speed. A “low-pass filter” in this disclosure can include a filter that passes signals with frequencies below a cutoff frequency and blocks (e.g., attenuates) signals with frequencies above the cutoff frequency. When a user manipulates the user interface to suddenly input the input yaw angle ψᵤₛₑᵣ, the yaw angular speed ω_{cmd} can be caused to carry a high-frequency component. By selecting a cutoff frequency for the first low-pass filter and applying the first low-pass filter to ω_{cmd}, the first low-pass filter can block the high-frequency component of ψᵤₛₑᵣ such that the movable object will only turn in accordance with a low-frequency component (e.g., below the cutoff frequency) of ω_{cmd}. By doing so, the movable object can reduce or avoid jerking due to the suddenly inputted input yaw angle ψᵤₛₑᵣ, and a video feed captured by a camera coupled to the movable object can reduce or avoid jittering.

By way of example, the filtered yaw angular speed (represented as ω_{filtered}) and the centripetal acceleration a_{y} can be determined based on Eqs. (3) to (4)

$${ω}_{filtered} = {lpf}_{1} ( {ω}_{cmd} ) \qquad Eq . ( 3 )$$

$${a}_{y} = {v}_{x} \cdot {ω}_{filtered} \qquad Eq . ( 4 )$$

where lpf₁(⋅) represents the first low-pass filter.

In some exemplary embodiments, to determine the centripetal acceleration, the processor can perform operations of receiving a predetermined coefficient associated with a slip angle or a skid angle from the user interface, and determining the centripetal acceleration based on the predetermined coefficient, the yaw angular speed, and the horizontal speed. For example, the predetermined coefficient can be associated with the skid angle (e.g., representing a skidding turn) when it has a value greater than a reference value (e.g., 1, 2, 3, or any non-zero number). The predetermined coefficient can be associated with the slip angle (e.g., representing a slipping turn) when it has a value smaller than the reference value. The predetermined coefficient can be associated with a zero skid or slip angle (e.g., representing a coordinated turn) when it has a value equal to the reference value. In some exemplary embodiments, the predetermined coefficient can be adjustable (e.g., by a user of the movable object). For example, the predetermined coefficient can be set via the user interface before operating the movable object. By adjusting or controlling the predetermined coefficient, the user of the movable object can control the banked turn of the movable object with higher flexibility and agility.

By way of example, the slip angle and the skid angle can be slip angle 310 and skid angle 306 as illustrated in FIG. 3, respectively. If the predetermined coefficient is represented as k, the centripetal acceleration (represented as a_{ycmd}) that is determined based on the predetermined coefficient k, the yaw angular speed ω_{cmd}, and the horizontal speed vₓ can be determined based on Eq. (5):

$${a}_{ycmd} = k \cdot {v}_{x} \cdot {ω}_{cmd} \qquad Eq . ( 5 )$$

where k=1 represents a coordinated turn (e.g., following path 302 in FIG. 3) of the movable object, k>1 represents a skidding turn (e.g., following path 304 in FIG. 3) of the movable object, and k<1 represents a slipping turn (e.g., following path 308 in FIG. 3) of the movable object. In some exemplary embodiments, the centripetal acceleration a_{ycmd} is determined based on the predetermined coefficient k, the filtered yaw angular speed ω_{filtered}, and the horizontal speed vₓ by replacing ω_{cmd} in Eq. (5) with ω_{filtered}.

In some exemplary embodiments, to determine the roll angle based on the yaw angular speed, the horizontal speed, and the third parameter value (i.e., the optional parameter value), the processor can perform operations of determining an inclination angle based on the yaw angular speed and the horizontal speed, and determining the roll angle based on the inclination angle and the third parameter value (e.g., representing a user-input roll angle). A “user-input roll angle” in this disclosure includes a roll angle inputted (e.g., from the user interface) to the movable object by which the movable object responds to roll. An “inclination angle” in this disclosure includes a roll angle automatically (e.g., without user intervention or interaction) determined by the processor associated with the movable object by which the movable object responds to roll in order to make a smoother turn in response to an input yaw angle (e.g., ψᵤₛₑᵣ). In some exemplary embodiments, a user of the movable object can send the user-input roll angle to the movable object intending to control the movable object to make a skidding turn or a slipping turn to perform a maneuver (e.g., during a racing game or stunt video shooting).

In some exemplary embodiments, when the third parameter value (i.e., the optional parameter value) represents a user-input roll angle, the processor can perform operations of determining the roll angle as a sum of the inclination angle and the user-input roll angle.

By way of example, if the inclination angle and the user-input roll angle are represented as ϕ_{ffd} and ϕᵤₛₑᵣ, respectively, the roll angle, represented as ϕ_{cmd}, can be determined based on Eqs. (6) to (7):

$${ϕ}_{ffd} = arctan ( \frac{{a}_{ycmd}}{g} ) \qquad Eq . ( 6 )$$

$${ϕ}_{cmd} = {ϕ}_{ffd} + {ϕ}_{user} \qquad Eq . ( 7 )$$

where g represents the gravitational acceleration, and arctan(⋅) represents the inverse tangent function.

In some exemplary embodiments, the processor can determine the roll angle ϕ_{cmd} based on Eqs. (1) to (7) using a control loop of a closed-loop controller communicatively coupled to the processor. A “closed-loop controller” (also referred to as a “feedback controller”) in this disclosure can include a controller that can automatically control (e.g., achieve, maintain, or regulate) a desired output (e.g., a setpoint or state) without external or manual interaction or intervention (e.g., by a user) by feeding all or part of its output to form part of its input or excitation (referred to as a “feedback process”). The closed-loop controller can include a forward path and a corresponding feedback path. The forward path and the corresponding feedback path can form a control loop, where all or part of the output of the forward path forms the input of the feedback path, and the output of the feedback path forms all or part of the input of the forward path. For example, the closed-loop controller can generate an output in the forward path based on an input, and feed all or part of the output (referred to as “feedback output”) in the corresponding feedback path to form part of its input. As an example, the closed-loop controller can generate a difference between the feedback output and the desired output and use the difference to form part of its input for re-generating the output in the forward path. By repeating so, the closed-loop controller can control the desired output over time. In some exemplary embodiments, the closed-loop controller can be a PID controller, and the control loop for determining the roll angle ϕ_{cmd} can be a position control loop.

In some exemplary embodiments, to determine the roll angle based on the second parameter value (i.e., the yaw angular speed parameter value) and the horizontal speed, the processor can perform operations of determining an input speed based on the user-input roll angle, determining a speed of the movable object based on the data of the sensing system, determining an adjusted roll angle based on the input speed and the speed of the movable object, and determining the roll angle as a sum of the inclination angle and the adjusted roll angle. A “speed” in this disclosure refers to a scalar speed of the movable object. The speed can include a lateral component (referred to as a “lateral speed”) and a tangential component (referred to as a “tangential speed”), in which the lateral speed is non-parallel (e.g., perpendicular) to the tangential speed. For example, the lateral speed can represent a speed of the movable object moving towards or away from a rotation axis of a circular motion (e.g., a banked turn) of the movable object. In some cases, a crosswind can cause the movable object to have the lateral speed.

An “input speed” in this disclosure refers to a speed automatically (e.g., without user intervention or interaction) determined by the processor associated with the movable object based on the user-input roll angle. The input speed can include a lateral component (referred to as an “input lateral speed”) and a tangential component (referred to as an “input tangential speed”), in which the input lateral speed is non-parallel (e.g., perpendicular) to the input tangential speed. In some exemplary embodiments, to determine the input lateral speed, the processor can perform operations of determining the input lateral speed based on at least one of the user-input roll angle or the centripetal acceleration.

In some exemplary embodiments, to determine the adjusted roll angle, the processor can perform operations of determining the adjusted roll angle using a first control loop of a closed-loop controller communicatively coupled to the processor. The first control loop can be nested inside a second control loop of the closed-loop controller. In some exemplary embodiments, the closed-loop controller (e.g., a PID controller) can include multiple control loops. The multiple control loops can be nested. For example, the closed-loop controller can include a first control loop nested inside a second control loop, where a first output of the forward path of the first control loop can form a first feedback output of the first control loop and part of a second output of the forward path of the second control loop, and the second output can form a second feedback output of the second control loop and part of a first input of the forward path of the first control loop. In some exemplary embodiments, the first control loop can be a velocity control loop, and the second control loop can be a position control loop.

By way of example, if the input lateral speed and the lateral speed are represented as v_{bcmd} and vₚ, respectively, the adjusted roll angle (represented as ϕ_{ctrl}) and the roll angle ϕ_{cmd} can be determined based on Eqs. (8) to (10):

$${v}_{bcmd} = F ( {ϕ}_{user} , {a}_{ycmd} ) \qquad Eq . ( 8 )$$

$${ϕ}_{ctrl} = {Vel}_{ctrl} ( {v}_{bcmd} , {v}_{b} ) \qquad Eq . ( 9 )$$

$${ϕ}_{cmd} = {ϕ}_{ffd} + {ϕ}_{ctrl} \qquad Eq . ( 10 )$$

where F(⋅) represents a mapping (e.g., a function) between the lateral speed v_{bcmd} and at least one of the user-input roll angle ϕᵤₛₑᵣ or the centripetal acceleration a_{ycmd}, and Vel_{ctrl}(⋅) represents a feedforward controller in a closed-loop controller coupled to the processor associated with the movable object. A “feedforward controller” in this disclosure can refer to a controller that can pass one or more signals (e.g., v_{bcmd} and v_{b}) from its external environment (e.g., a user input or a measurement) to a load (e.g., ϕ_{ctrl}) in its external environment for automatically determining and adjusting the load. For example, the feedforward controller Vel_{ctrl}(⋅) can be a velocity control loop of the closed-loop controller. By way of example, the closed-loop controller can be one or more devices integrated in or communicatively coupled to controller 103 in FIG. 1.

By using the feedforward controller to determine the adjusted roll angle based on the user-input roll angle, the processor can control the roll angle of the movable object using the speed feedback information of the movable object and thus reduce or avoid jerking, slipping, or skidding of the movable object due to environmental impact (e.g., a crosswind).

By way of example, the mapping F(⋅) in Eq. (8) can be implemented based on either Eq. (11) or (12):

$${v}_{bcmd} = f ( {ϕ}_{user} ) \qquad Eq . ( 11 )$$

$${v}_{bcmd} = \int ( {a}_{ycmd} - {a}_{y} ) dt \qquad Eq . ( 12 )$$

where f(⋅) represents a mapping (e.g., a linear or non-linear function) between the user-input roll angle ϕᵤₛₑᵣ and the lateral speed v_{bcmd}. It should be noted that f(⋅) can be implemented in various manners and is not limited to the exemplary embodiments as described herein.

Consistent with some exemplary embodiments of this disclosure, the processor can further perform operations of controlling the movable object to perform a banked turn in accordance with the determined roll angle. In some exemplary embodiments, to control the movable object to perform the banked turn, the processor can perform operations of controlling the movable object to perform the banked turn with the slip angle or the skid angle based on the predetermined coefficient.

By way of example, the roll angle can be ϕ_{cmd} as described in association with Eqs. (1) to (12). By way of example, the slip angle or the skid angle can be associated with the predetermined coefficient k as described in association with Eqs. (1) to (12).

In some exemplary embodiments, to control the movable object to perform the banked turn, the processor can perform operations of determining a filtered roll angle by applying a second low-pass filter to the roll angle in response to the second parameter value (i.e., the yaw angular speed parameter value) changing to represent a substantially zero yaw angular speed (e.g., being within a range of ±0.1 rad/s), and controlling the movable object to perform the banked turn in accordance with the filtered roll angle. For example, if the user interface includes a joystick for controlling the yaw angle, when a user of the movable object pushes a control column of the joystick away from a neutral position of the control column, the second parameter value represents a non-zero yaw angular speed. When the user releases the control column, the control column can return and stay in the neutral position, where the second parameter value changes to represent a substantially zero yaw angular speed (e.g., being within a range of ±0.1 rad/s).

When the user suddenly releases the control column of the joystick, the roll angle determined based on the yaw-control parameter and the horizontal speed can be caused to carry a high-frequency component. By selecting a cutoff frequency for the second low-pass filter and applying the second low-pass filter to the roll angle, the second low-pass filter can block the high-frequency component such that the movable object will only make the banked turn in accordance to a low-frequency component (e.g., below the cutoff frequency) of the roll angle. By doing so, the sudden release of the control column of the joy stick can be effectively attenuated to be a slow, gradual release of the control column, in which the movable object can reduce or avoid jerking due to the suddenly changed input yaw angle, and a video feed captured by a camera coupled to the movable object can reduce or avoid jittering.

By way of example, the processor can apply the second low-pass filter to the roll angle ϕ_{cmd} to determine the filtered roll angle (represented as ϕ_{filtered}) based on Eq. (13):

$${ϕ}_{filtered} = \{ \begin{matrix}{ϕ}_{cmd} & for {ψ}_{user} \neq 0 \\ {lpf}_{2} ( {ϕ}_{cmd} ) & when {ψ}_{user} changes to 0\end{matrix} \qquad Eq . ( 13 )$$

where lpf₂(⋅) represents the second low-pass filter, and ϕ_{cmd} can be determined based on Eq. (7) or (10).

Consistent with some exemplary embodiments of this disclosure, after controlling the movable object to perform the banked turn, the processor can further perform operations of determining a current roll angle of the movable object based on the data of the sensing system and controlling to adjust a posture of the movable object based on the roll angle and the current roll angle. A “current roll angle” in this disclosure refers to a measured roll angle of the movable object. A “posture” of the movable object in this disclosure can include any positional characteristic of the movable object, such as a roll angle, a yaw angle, a pitch angle, or any combination thereof. In some exemplary embodiments, the processor can adjust the posture of the movable object using a position control loop of the closed-loop controller coupled to the processor.

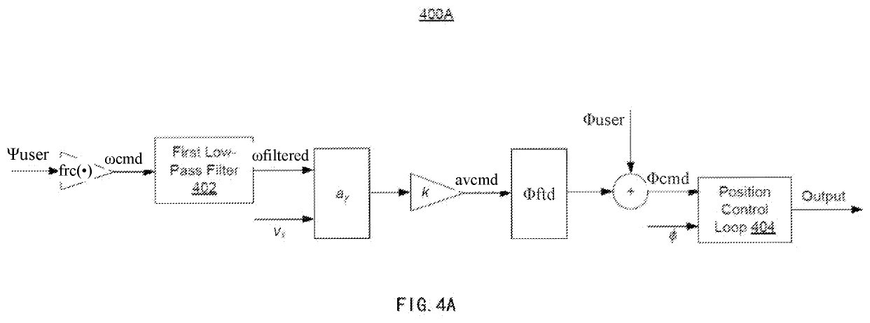

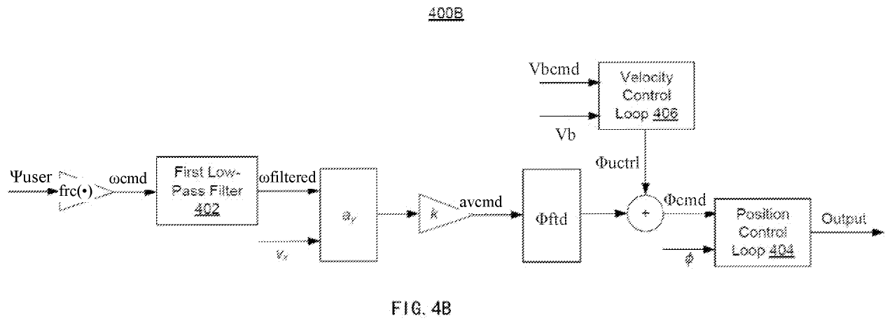

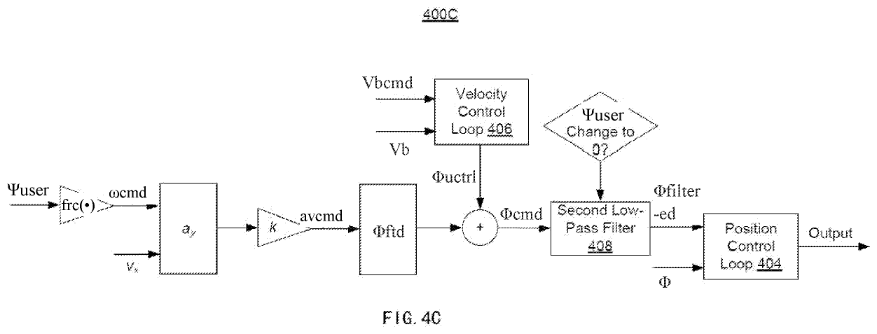

By way of example, FIGS. 4A-4C illustrate example diagrams of control paths 400A-400C for controlling, by a processor, a movable object making turns, consistent with some exemplary embodiments of this disclosure. For example, the movable object can be movable object 102 illustrated and described in association of FIGS. 1-3 and Eqs. (1) to (13), and the movable object can be making a banked turn. In some exemplary embodiments, a processor (e.g., controller 103 of FIG. 1) associated with the movable object can execute control paths 400A-400C. It should be noted that various control paths can be implemented for the movable object to make turns, and this disclosure does not limit the various control paths to control paths 400A-400C.

As illustrated in FIG. 4A, in control path 400A, the processor associated with the movable object uses a yaw angle ψᵤₛₑᵣ as input. For example, the input yaw angle ψᵤₛₑᵣ can be represented by the second parameter value (i.e., the yaw angular speed parameter value) received (e.g., via communication system 105 in FIG. 1) by the movable object from the user interface (e.g., implemented on remote controller 130 or mobile device 140 in FIG. 1). The processor applies a mapping function f_{rc}(⋅) (e.g., the mapping function f_{rc}(⋅) as described with reference to Eq. (1)) to the input yaw angle ψᵤₛₑᵣ to generate a yaw angular speed ω_{cmd} (e.g., the angular speed ω_{cmd} as described with reference to Eq. (1)). The processor then applies a first low-pass filter 402 (e.g., the first low-pass filter lpf₁(⋅) as described in Eq. (3)) to ω_{cmd} to generate a filtered yaw angular speed ω_{filtered} (e.g., the filtered yaw angular speed ω_{filtered} as described with reference to Eq. (3)). Using ω_{filtered} and a horizontal speed vₓ of the movable object as inputs, the processor determines a centripetal acceleration a_{y} (e.g., the centripetal acceleration a_{y} as described with reference to Eq. (4)). For example, the processor can determine the horizontal speed vₓ based on data of a sensing system (e.g., sensing system 101 in FIG. 1) of the movable object.

The processor then applies (e.g., multiply) a predetermined coefficient k (e.g., the predetermined coefficient k as described in Eq. (5)) to a_{y} to determine a centripetal acceleration a_{ycmd} (e.g., the centripetal acceleration a_{ycmd} as described with reference to Eq. (5)). Based on a_{ycmd}, the processor determines an inclination angle ϕ_{ffd} (e.g., the inclination angle ϕ_{ffd} as described with reference to Eq. (6)). The processor then determines a roll angle ϕ_{cmd} (e.g., the roll angle ϕ_{cmd} as described with reference to Eq. (7)) by summing ϕ_{ffd} and a user-input roll angle ϕᵤₛₑᵣ. For example, the user-input roll angle ϕᵤₛₑᵣ can be represented by the third parameter value received (e.g., via communication system 105 in FIG. 1) by the movable object from a user interface (e.g., implemented on remote controller 130 or mobile device 140 in FIG. 1).

The processor can then input ϕ_{cmd} and a current roll angle ϕ of the movable object to a position control loop 404 of a closed-loop controller coupled to the movable object for generating an output. The output can be used to adjust a posture (e.g., a roll angle, a pitch angle, a yaw angle, or a combination thereof) of the movable object. In some exemplary embodiments, the processor can determine the current roll angle ϕ based on the data of the sensing system (e.g., sensing system 101 in FIG. 1) of the movable object, such as positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object.

As illustrated in FIG. 4B, control path 400B is similar to control path 400A as described above except that the user-input roll angle ϕᵤₛₑᵣ used in determining the roll angle ϕ_{cmd} is replaced by an adjusted roll angle ϕ_{ctrl} (e.g., the adjusted roll angle ¢ctrl as described with reference to Eq. (9)). For example, the processor determines the roll angle ϕ_{cmd} in control path 400B based on Eq. (10). The processor associated with the movable object can input an input lateral speed v_{bcmd} (e.g., the input lateral speed v_{bcmd} as described with reference to Eqs. (8), (11) or (12)) and a lateral speed v_{b} to a velocity control loop 406 of the closed-loop controller for determining ϕ_{ctrl}. In some exemplary embodiments, the processor determines the lateral speed v_{b} based on the data of the sensing system (e.g., sensing system 101 in FIG. 1) of the movable object. Compared with control path 400A, control path 400B can use both positional control loop 404 and velocity control loop 406 for adjusting the posture of the movable object.

As illustrated in FIG. 4C, control path 400C is similar to control path 400B as described above except that the processor associated with the movable object does not apply first low-pass filter 402 to generate the filtered yaw angular speed ω_{filtered} but directly uses the yaw angular speed ω_{cmd} as one of the inputs to determine the centripetal acceleration a_{y}. Also, after determining the roll angle ϕ_{cmd} (e.g., the roll angle ϕ_{cmd} as described with reference to Eq. (10)), the processor applies a second low-pass filter 408 (e.g., the second low-pass filter lpf₂(⋅) as described in Eq. (13)) to ϕ_{cmd} to determine a filtered roll angle ϕ_{filtered} (e.g., the filtered roll angle ϕ_{filtered} as described with reference to Eq. (13)). For example, the processor can determine the filtered roll angle ϕ_{filtered} depending on whether the input yaw angle ψᵤₛₑᵣ is changing to substantially zero (e.g., being within a range of ±0.1°) in accordance with Eq. (13). The processor then inputs ϕ_{filtered} and the current roll angle ϕ to position control loop 404 for generating the output. Compared with control path 400B, control path 400C can attenuate a sudden change of ψᵤₛₑᵣ during a turn to reduce or avoid jerking of the movable object.

In some exemplary embodiments, besides controlling the movable object to perform the banked turn, the processor associated with the movable object can further enable different control modes for controlling the performance of the banked turns to adapt to various user demands. For example, when the user is an unskilled user, the user can have a demand emphasizing safety of operating the movable object and thus prefer less aggressive control logic for maneuvering the movable object. In another example, when the user is a skilled user (e.g., in a racing game), the user can have a demand emphasizing flexibility and agility of operating the movable object and thus prefer more aggressive control logic for maneuvering the movable object. As yet another example, when the user prioritize video shooting quality of a camera coupled to the movable object over operating the movable object, the user can have a demand emphasizing smoothness (e.g., less jerking of the movable object or less jittering of the video) of operating the movable object and the camera, and thus prefer a suitable control logic for maneuvering the movable object.

In some exemplary embodiments, the movable object can be controlled under one or more control modes. The one or more control modes can have different control logic for controlling the movable object to move at different aggressiveness levels. For example, the movable object can be controlled under a first control mode (e.g., configured for beginners), a second control mode (e.g., configured for photographers), and a third control mode (e.g., configured for racers), in which the control logic of the first control mode can be less aggressive than the control logic of the second control mode, and the control logic of the second control mode can be less aggressive than the third control mode.

By way of example, the aggressiveness levels of controlling the movable object to move can be implemented by enabling, disabling, or setting different ranges for flight control parameters in different control modes. For example, the aggressiveness levels can be adjusted by changing limits on at least one of a pitch angle, a yaw angle, a roll angle, a height, a speed (e.g., a horizontal speed, a vertical speed, or a yaw angular speed), an acceleration or deceleration (e.g., a horizontal acceleration or deceleration, a vertical acceleration or deceleration, a yaw angular acceleration or deceleration), or any other flight control parameters related to the motion of the movable object. It should be noted that the control modes can be implemented in various manners and are not limited to the exemplary embodiments described herein.

Consistent with some exemplary embodiments of this disclosure, the processor can further perform operations of, in response to receiving a control-mode signal from the user interface, controlling the movable object to move in a control mode. In response to the movable object being controlled to move in the control mode, the processor can further perform operations of setting at least one of the horizontal speed, the input yaw angle, the yaw angular speed, or the predetermined coefficient not to exceed a range. In some exemplary embodiments, the range can be predetermined as a default value. In some exemplary embodiments, the range can be set by the user. For example, an unskilled user can operate the movable object in the control mode to activate less aggressive control logics (e.g., wider turns, less skidding or slipping, smaller ranges of motion, or lower speeds) for maneuvering the movable object. In some exemplary embodiments, the processor can receive the control-mode signal from a switch, a button, a slider, a wheel, or any physical or virtual module of the user interface.

In some exemplary embodiments, in the control mode, the processor can limit the horizontal speed (e.g., by setting an upper limit or a range thereof) to reduce the risk of an unexpected collision. The processor can limit the input yaw angle (e.g., by setting an upper limit or a range thereof) to reduce the risk of an unexpected crash. The processor can limit the predetermined coefficient (e.g., by setting an upper limit or a range thereof) to confine the skid or slip angle when making turns, or even to prohibit any skid or slip angle where only coordinated turns are allowed.

By way of example, in some exemplary embodiments, the processor can set an upper limit for the input yaw angle (e.g., user as described in association with Eqs. (1) to (13) and FIGS. 4A-4C) such that a corresponding yaw angular speed (e.g., ω_{cmd} as described in association with Eqs. (1) to (13) and FIGS. 4A-4C) can have a predetermined upper limit (e.g., 150 rad per second, or any rad per second). In some exemplary embodiments, the processor can set a range (e.g., 0 to 0.2, or any range) for the predetermined coefficient (e.g., k as described in association with Eqs. (1) to (13) and FIGS. 4A-4C). For example, the predetermined upper limit of the yaw angular speed or the range of the predetermined coefficient can be set in response to a user input received (e.g., from the user interface) by the processor.

Consistent with some exemplary embodiments of this disclosure, the processor can further perform operations of, in response to receiving a control-mode signal from the user interface, controlling the movable object to move in a control mode. In response to the movable object being controlled to move in the control mode, the processor can further perform operations of increasing at least one of a value of the predetermined coefficient or a bandwidth of a control loop of a closed-loop controller communicatively coupled to the processor. For example, a skilled user can operate the movable object in the control mode to activate more aggressive control logics (e.g., sharper turns, larger ranges of motion, or higher speeds) for maneuvering the movable object. A “bandwidth” of a control loop of a closed-loop controller, as used herein, can refer to one or more parameters that affect how fast (e.g., characterized by a frequency) the control loop can change its output in response to a change of its input. For example, the bandwidth can include a gain (e.g., a gain for amplification of an input) of the control loop. A higher bandwidth (e.g., a higher gain) can enable the control loop to respond faster.

In some exemplary embodiments, in the control mode, the processor can increase a value of the predetermined coefficient (e.g., a value set by the user before operating the movable object) to enable more aggressive skidding or slipping without compromising stability of the movable object. In some exemplary embodiments, the processor can increase the bandwidth (e.g., a gain) of the control loop (e.g., a velocity control loop) to quicken the response of the movable object when receiving a control parameter (e.g., a roll-control parameter, a yaw-control parameter, or any control parameter).

Consistent with some exemplary embodiments of this disclosure, the processor can further perform operations of, in response to receiving a control-mode signal from the user interface, controlling the movable object to move in a control mode. In response to the movable object being controlled to move in the control mode, the processor can further perform operations of decreasing at least one of the value of the predetermined coefficient or a bandwidth of a control loop of a closed-loop controller communicatively coupled to the processor in response to the second parameter value (i.e., the yaw angular speed parameter value) representing a non-zero yaw angular speed, and increasing the bandwidth in response to the second parameter value changing to represent a substantially zero yaw angular speed (e.g., being within a range of ±0.1 rad/s). For example, a user prioritizing video shooting over operating the movable object can operate the movable object in the control mode to activate dynamic control logics (e.g., smoother turns, less skidding or slipping, or less jerking) for maneuvering the movable object.

In some exemplary embodiments, in the control mode, during the movable object making a turn (e.g., the second parameter value representing a non-zero yaw angular speed), the processor can decrease a value of the predetermined coefficient (e.g., a value set by the user before operating the movable object) to enable less aggressive skidding or slipping. In some exemplary embodiments, during the movable object making the turn, the processor can decrease the bandwidth (e.g., a gain) of the control loop (e.g., a velocity control loop) to slow the response of the movable object. In some exemplary embodiments, after the movable object completes the turn (e.g., the second parameter value changing to represent a substantially zero yaw angular speed), the processor can increase the bandwidth of the control loop to restore or quicken the response of the movable object. By doing so, the processor can dynamically adjust the bandwidth of the control loop depending on stages of making the turn, in which the slipping or skidding of the movable object can be reduced. Such a dynamic control logic can reduce or avoid jerking of the movable object during and after turns, and can reduce or avoid jittering of a video feed captured by a camera coupled to the movable object.

Consistent with some exemplary embodiments of this disclosure, the operations of the embodiments to control turning of the movable object can be combined with the operations of the embodiments to control the horizontal speed of the movable object to provide a technical solution to control both the turning and the horizontal speed of the movable object. It should be noted that such a combination can be implemented in any arrangement, and this disclosure does not limit the manner of combining the operations of such embodiments.

Some aspects of this disclosure can provide a technical solution to control a vertical speed of the movable object. A “vertical speed” in this disclosure can refer to a speed of the movable object along a vertical direction (e.g., toward the sky or the ground).

Consistent with some exemplary embodiments of this disclosure, the processor associated with the movable object can perform operations of receiving a fourth parameter value representing a throttle from a user interface communicatively coupled to the movable object. A “fourth parameter value” (also referred to herein as a “throttle parameter value”) in this disclosure includes a parameter value for controlling a thrust of the movable object in the vertical direction. While the fourth parameter has been disclosed herein as corresponding to a particular parameter value, the disclosure is not so limited. Embodiments can be practiced with equal effectiveness utilizing another parameter as the fourth parameter that facilitates control of the movable object. The thrust can cause the movable object to ascend, descend, or hover in the vertical direction.

Consistent with some exemplary embodiments of this disclosure, the processor associated with the movable object can also perform operations of determining a rotation rate of a motor coupled to the movable object based on a relationship (e.g., a linear or nonlinear relationship) between the rotation rate and the fourth parameter value (i.e., the throttle parameter value). In some exemplary embodiments, the motor can be configured to drive a propeller. A “rotation rate” of the motor in this disclosure includes a speed at which a rotary component (e.g., a propeller) coupled to the motor rotates about an axis. A “linear relationship” in this disclosure refers to a relationship between a variable x (e.g., the fourth parameter value) and a variable y (e.g., the rotation rate) in the form of y=mx+b where m and b are constants.

By way of example, the motor can include a motor in propulsion devices 205 in FIG. 2. The rotary component can be one of rotary components 207 in FIG. 2.

In some exemplary embodiments, the user interface can include a control module (e.g., a joystick) that includes a movable part (e.g., a control column) having a neutral position. In some exemplary embodiments, the control module can be configured to control the rotation rate of the motor. In some exemplary embodiments, to receive the fourth parameter value, the processor can perform operations of receiving the fourth parameter value from the control module. The fourth parameter value (i.e., the throttle parameter value) can represent a displacement of the movable part from the neutral position in a direction (e.g., a forward, backward, left, or right direction, or a combination thereof).

In some exemplary embodiments, to determine the rotation rate of the motor, the processor performs operations of determining the rotation rate of the motor based on the relationship (e.g., a linear relationship) when the direction is a first direction. For example, the first direction can be a forward, backward, left, or right direction, or a combination thereof.

Consistent with some exemplary embodiments of this disclosure, the processor associated with the movable object further performs operations of controlling the movable object to ascend. The motor can rotate in accordance with the rotation rate. When the user controls the movable object to ascend, the processor directly maps the fourth parameter value to the rotation rate of the motor, which enables the movable object to ascend in quick response to the throttle control and increase a user's excitement of operating the movable object.

Consistent with some exemplary embodiments of this disclosure, the processor can further perform operations of determining a vertical target speed based on the fourth parameter value (i.e., the throttle parameter value) when the direction is a second direction different from (e.g., opposite to) the first direction or when the fourth parameter value represents that the movable part is at the neutral position, and controlling the movable object to move at the vertical target speed. A “vertical target speed” in this disclosure refers to a vertical speed set as a target for the movable object to reach. For example, when the direction of the movable part of the control module is in the second direction or at the neutral position, the processor can map the fourth parameter value (i.e., the throttle parameter value) to the vertical target speed instead of the rotation rate of the motor, and thus control the movable object to accelerate or decelerate in a constant or non-constant vertical acceleration to reach the vertical target speed.

In some exemplary embodiments, the vertical target speed can be zero when the fourth parameter value (i.e., the throttle parameter value) represents that the movable part is at the neutral position. In some exemplary embodiments, when the vertical target speed is zero, to control the movable object to move at the vertical target speed, the processor can perform operations of controlling the movable object to stop at a substantially zero speed (e.g., being within a range of ±1 cm/s) in a vertical direction using a first control loop of a closed-loop controller communicatively coupled to the processor. The first control loop can be nested inside a second control loop of the closed-loop controller. For example, the closed-loop controller (e.g., a PID controller) can include at least two control loops (e.g., including the first control loop and the second control loop). In some exemplary embodiments, the first control loop can be a vertical velocity control loop, and the second control loop can be a position control loop.

When the user of the movable object releases the movable part (e.g., the control column) of the control module (e.g., the joystick) for controlling the fourth parameter value (i.e., the throttle parameter value), the movable part can return and stay at the neutral position. In such a situation, the processor can automatically control the movable object (e.g., using a vertical velocity control loop) to quickly stop in the vertical direction without user intervention or interaction, thus simplifying operation of the movable object.

In some exemplary embodiments, the vertical target speed can be non-zero when the direction is the second direction. In some exemplary embodiments, when the vertical target speed is non-zero, to control the movable object to move at the vertical target speed, the processor can perform operations of controlling the movable object to accelerate or decelerate to the vertical target speed in accordance with a constant acceleration (e.g., a constant vertical acceleration).

In some exemplary embodiments, to control the movable object to accelerate or decelerate to the vertical target speed, the processor can perform operations of controlling the movable object to accelerate or decelerate in a vertical direction using a first control loop and a second control loop of a closed-loop controller communicatively coupled to the processor. The second control loop can be nested inside the first control loop. For example, the closed-loop controller (e.g., a PID controller) can include at least three control loops (e.g., including the first control loop, the first control loop, and the second control loop). In some exemplary embodiments, the first control loop can be a vertical velocity control loop, the first control loop can be a position control loop, and the second control loop can be a vertical acceleration control loop. For example, the second control loop can be nested inside the first control loop that is nested inside the first control loop.

When the user controls the movable object to descend or decelerate during ascending, the processor can map (e.g., using the vertical velocity control loop and the vertical acceleration control loop) the fourth parameter value (i.e., the throttle parameter value) to the non-zero vertical target speed and the constant acceleration instead of the rotation rate of the motor, and thus can control the movable object to smoothly accelerate or decelerate to reach the vertical target speed. By doing so, the operations of the movable object can be simplified and uniformized, the user can better predict the ascend or descend path of the movable object, and a video feed capture by a camera coupled to the movable object can be more stable.

The embodiments to control the vertical speed of the movable object can be combined with the embodiments to control the horizontal speed of the movable object and/or the embodiments to control turning of the movable object, so as to provide a technical solution to control any combination of the turning, the horizontal speed, and the vertical speed of the movable object. It should be noted that such a combination can be implemented in any arrangement, and this disclosure does not limit the manners of combining the operations of such embodiments.

Some aspects of this disclosure can provide a technical solution to provide safety protection to the operations of the movable object. For example, such a technical solution can set a lower limit to an altitude of the movable object to reduce or avoid a risk of crashing. In another example, such a technical solution can set an upper limit to the moving speed of the movable object for obstacle avoidance. As yet another example, such a solution can provide a manual or automatic mechanism for quickly stopping the movable object in at least one of the horizontal direction or the vertical direction, which can reduce or avoid dangers in emergency, or can provide a manner for the user of the movable object to disengage the operation for a quick rest.

Consistent with some exemplary embodiments of this disclosure, the processor associated with the movable object can perform operations of receiving data from a sensing system communicatively coupled to the processor. For example, the data received from the sensing system can include positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object. By way of example, the sensing system can be sensing system 101 as illustrated and described in FIG. 1.

Consistent with some exemplary embodiments of this disclosure, the processor can also perform operations of determining a speed limit based on the data received from the sensing system. For example, the speed limit can include an upper limit, a lower limit, or a range for a moving speed of the movable object.

Consistent with some exemplary embodiments of this disclosure, the processor can further perform operations of disabling the movable object from moving faster than the speed limit. The speed limit can be either zero or non-zero. When the speed limit is non-zero, the movable object can still move under or at the speed limit even if the user does not send any speed-control parameter (e.g., a pitch-control parameter) to the movable object. In some exemplary embodiments, to disable the movable object to prevent it from moving faster than the speed limit, the processor can further perform operations of controlling the movable object to decelerate to the speed limit when a speed of the movable object is higher than the speed limit.

Consistent with some exemplary embodiments of this disclosure, the processor can set a limit to an altitude of the movable object to reduce or avoid a risk of crashing. In some exemplary embodiments, when the data received from the sensing system includes an altitude (e.g., a height) of the movable object above ground, and the speed limit includes a vertical speed limit, the processor can perform operations of determining the vertical speed limit based on the altitude when the altitude is below a first threshold altitude, and disabling (e.g., by setting a limit to the fourth parameter value) the movable object from moving toward the ground faster than the vertical speed limit. For example, the sensing system can include a vision sensor (e.g., a monocular or binocular vision sensor) for sensing the altitude. In some exemplary embodiments, when the movable object is below the first threshold altitude, a risk of crashing can increase if the movable object descends too fast. By preventing the movable object from exceeding the vertical speed limit if it moves toward the ground, the risk of crashing can be confined to a lower level, and the safety of operating the movable object can be increased. If the vertical speed limit is non-zero, the user's freedom to maneuvering the movable object can also be maintained.

Consistent with some exemplary embodiments of this disclosure, when the data includes the altitude, and the speed limit includes the vertical speed limit, the processor can further perform operations of controlling the movable object to stop moving toward the ground when the altitude is below a second threshold altitude. For example, the second threshold altitude can be lower than the first threshold altitude. In some exemplary embodiments, when the movable object is below the second threshold altitude, a risk of crashing can increase to the level that stopping the movable object from descending is the only safe measure to be adopted. By doing so, the crashing of the movable object can be avoided.

Consistent with some exemplary embodiments of this disclosure, the processor can set a limit to the moving speed of the movable object for obstacle avoidance. In some exemplary embodiments, when the data includes a distance between the movable object and an obstacle in front of the movable object, and the speed limit includes a horizontal speed limit, the processor can perform operations of determining the horizontal speed limit based on the distance when the distance is closer than a first threshold distance, and disabling (e.g., by setting a limit to the parameter value) the movable object from moving toward the obstacle faster than the horizontal speed limit. An “obstacle” in front of the movable object in this disclosure can include any physical object (e.g., a building, a tree, a vehicle, an animal, or a human being) within a certain proximity to a projected flight path of the movable object such that the movable object will touch or collide with the physical object if it follows the projected flight path. For example, the sensing system can include a vision sensor (e.g., a time-of-flight vision sensor) for sensing the distance. In some exemplary embodiments, when the distance is shorter than the first threshold distance, a risk of collision can increase if the movable object moves too fast. By forcing the movable object to not exceed the horizontal speed limit if it moves toward the obstacle, the risk of collision can be confined to a lower level, and the safety of operating the movable object can be increased. If the horizontal speed limit is non-zero, the user's freedom to maneuvering the movable object can also be maintained.

In some exemplary embodiments, when the data includes the distance between the movable object and the obstacle, and the speed limit includes the horizontal speed limit, the processor can perform operations of controlling the movable object to stop moving toward the obstacle when the distance is closer than a second threshold distance. For example, the second threshold distance can be shorter than the first threshold distance. In some exemplary embodiments, when the distance is closer than the second threshold distance, a risk of collision can increase to the level that stopping the movable object from moving is the only safe measure to be adopted. By doing so, the collision of the movable object can be avoided.

Consistent with some exemplary embodiments of this disclosure, the processor can control the movable object to perform a quick stop. In some exemplary embodiments, the processor can perform operations of, in response to receiving a stop signal from a user interface communicatively coupled to the movable object, controlling the movable object to stop at a substantially zero speed (e.g., being within a range of ±1 cm/s) in at least one of a horizontal direction or a vertical direction. In some exemplary embodiments, the processor can receive the stop signal from a switch, a button, a slider, a wheel, or any physical or virtual module of the user interface. For example, the processor can receive the stop signal from a physical or virtual emergency stop button on the user interface.

In some exemplary embodiments, to control the movable object to stop at the substantially zero speed, the processor can perform operations of controlling to increase at least one of a bandwidth (e.g., a gain) of a first control loop of a closed-loop controller communicatively coupled to the processor or a bandwidth (e.g., a gain) of a second control loop of the closed-loop controller. The first control loop can be configured to control a horizontal movement of the movable object. The second control loop can be configured to control a vertical movement of the movable object. The closed-loop controller (e.g., a PID controller) can include multiple control loops (e.g., including the first control loop and the second control loop). Increasing the bandwidth of the first or second control loop can quicken the response of the movable object to move in the horizontal or vertical direction, respectively.

For example, the processor can control to increase the bandwidth of the first control loop for stopping the movable object in the horizontal direction. In another example, the processor can control to increase the bandwidth of the second control loop for stopping the movable object in the vertical direction. As yet another example, the processor can control to increase both the bandwidths of the first and second control loops for stopping the movable object in the both the horizontal and vertical directions. In some exemplary embodiments, after stopping the movable object in at least one of the horizontal direction or the vertical direction, the processor can control to restore at least one of the bandwidth of the first control loop or the bandwidth of the second control loop.

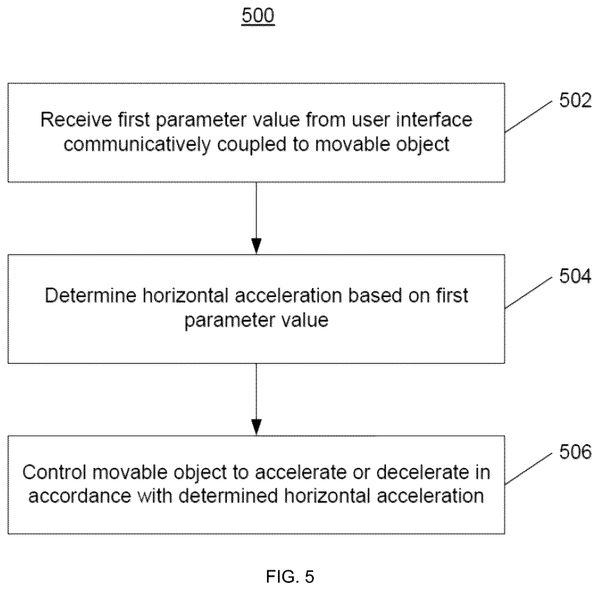

By way of example, FIGS. 5-10 illustrate flowcharts of example methods 500-1000 consistent with some exemplary embodiments of this disclosure. Methods 500-1000 can be performed by a processor (e.g., controller 103 in FIG. 1) associated with a movable object (e.g., movable object 102) to implement the above-described operations, including operations as illustrated and described in association with FIGS. 1-4C. In some exemplary embodiments, methods 500-1000 can be performed by the processor associated with the movable object and a processor of a device (e.g., remote controller 130, mobile device 140, or server 110 in FIG. 1) associated with the movable object. In some exemplary embodiments, methods 500-1000 can be implemented as a computer program product (e.g., embodied in a non-transitory computer-readable medium) that includes computer-executable instructions (e.g., program codes or processor instructions) to be executed by the processor. In some exemplary embodiments, methods 500-1000 can be implemented as a hardware product (e.g., including any combination logic or storage circuitry). In some exemplary embodiments, methods 500-1000 can be implemented as a combination of a computer program product and the hardware product.

FIG. 5 illustrates a flowchart of an example method 500 for controlling a horizontal speed of a movable object, consistent with some exemplary embodiments of this disclosure. At step 502, a processor (e.g., controller 103 in FIG. 1) associated with a movable object (e.g., movable object 102) receives (e.g., via communication system 105 in FIG. 1) the first parameter value from a user interface communicatively coupled to the movable object. For example, the movable object can include an unmanned aerial vehicle (UAV). In some exemplary embodiments, the user interface can be communicatively coupled to the movable object via a wireless network (e.g., network 120 in FIG. 1). In some exemplary embodiments, the user interface can include a physical user interface on a remote controller (e.g., remote controller 130 in FIG. 1) or a graphical user interface (GUI) on a screen (e.g., display device 131 or a screen of mobile device 140 in FIG. 1).

In some exemplary embodiments, as described above, the user interface can include a control module including a movable part having a neutral position. For example, the control module can include a physical stick (e.g., a joystick), a lever, a switch, a knob, a slider, a wheel, a wearable apparatus, a touchable display, a button, or any physical or virtual module that includes a movable part having a neutral position. For example, if the control module is a joystick, the movable part can be a control column. In some exemplary embodiments, the control module can be configured to control at least one of a pitch angle of the movable object or a horizontal speed of the movable object.

In some exemplary embodiments, the processor receives (e.g., via communication system 105 in FIG. 1) the parameter value from the control module. As described above, the parameter value represents a displacement of the movable part from the neutral position in a direction (e.g., a forward, backward, left, or right direction, or a combination thereof).

Still referring to FIG. 5, at step 504, the processor determines a horizontal acceleration based on the first parameter value. The horizontal acceleration can be substantially zero (e.g., being within a range of ±1 cm/s2) when the first parameter value is zero. In some exemplary embodiments, the horizontal acceleration can have a mapping relationship with the first parameter value. In some exemplary embodiments, the horizontal acceleration can have a mapping relationship with the displacement of the movable part from the neutral position. In some exemplary embodiments, the processor can determine the horizontal acceleration as positive when the direction is a first direction (e.g., a forward direction). The processor can determine the horizontal acceleration as negative when the direction is a second direction (e.g., a backward direction) different from the first direction. The processor can determine the horizontal acceleration as substantially zero (e.g., being within a range of ±1 cm/s2) when the first parameter value represents that the movable part is at the neutral position.

In some exemplary embodiments, when the direction is the second direction, the processor can determine whether the first parameter value exceeds a threshold value. In response to the first parameter value not exceeding the threshold value, the processor can determine the horizontal acceleration to be a negative value corresponding to the first parameter value. In response to the first parameter value exceeding the threshold value, the processor can determine the horizontal acceleration to be a negative value corresponding to a maximum displacement in the second direction. In some exemplary embodiments, the processor can determine the horizontal acceleration as substantially zero (e.g., being within a range of ±1 cm/s2) in response to the movable object stopping (e.g., moving at a substantially zero speed) in the second direction.

Still referring to FIG. 5, at step 506, the processor controls the movable object to accelerate or decelerate in accordance with the horizontal acceleration. In some exemplary embodiments, the processor determines a horizontal speed limit based on the first parameter value. For example, the processor can control the movable object to accelerate in accordance with the horizontal acceleration when the horizontal acceleration is positive and a horizontal speed of the movable object is below the horizontal speed limit. In another example, the processor can control the movable object to decelerate in accordance with the horizontal acceleration when the horizontal acceleration is negative and the horizontal speed of the movable object is above the horizontal speed limit.

In some exemplary embodiments, when the horizontal acceleration is negative and the horizontal speed of the movable object is above the horizontal speed limit, the processor controls the movable object to decelerate to stop in a moving direction of the movable object. In some exemplary embodiments, the horizontal speed limit can have a mapping relationship (e.g., a positive correlation or a proportional relationship) with the parameter value.

Consistent with some exemplary embodiments of method 500, the processor can further receive (e.g., via communication system 105 in FIG. 1) a resetting signal from the user interface and control the movable object to accelerate in a direction opposite to the moving direction in accordance with the horizontal acceleration. In some exemplary embodiments, the processor can further activate a vision sensor communicatively coupled to the movable object. The vision sensor can face the direction opposite to the moving direction.

Consistent with some exemplary embodiments of method 500, the processor can further determine a value of a mode signal representing a first mode or a second mode. For example, the processor can receive the mode signal from a mode selection module of the user interface (e.g., via communication system 105 in FIG. 1). In another example, the processor can determine the mode signal in response to a sensing system (e.g., sensing system 101 in FIG. 1) communicatively coupled to the processor receiving data representing a predetermined condition. The predetermined condition can include at least one of a condition that the movable object moves at a speed below a predetermined speed limit or a condition that an altitude of the movable object is below a predetermined altitude limit (e.g., during taking off or landing). For example, the data received from the sensing system can include positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object. In response to the mode signal representing the first mode, the processor can control the movable object to accelerate or decelerate in accordance with the horizontal acceleration. In response to the mode signal representing the second mode, the processor can determine a horizontal target speed based on the parameter value and control the movable object to move at the horizontal target speed.

Consistent with some exemplary embodiments of method 500, the processor can determine a camera pitch angle based on the parameter value, and control a camera (e.g., payload 235 in FIG. 2) coupled to the movable object to point downward by the camera pitch angle when the movable object accelerates. In some exemplary embodiments, the camera pitch angle can have a mapping relationship with the horizontal acceleration. In some exemplary embodiments, as described above, to control the camera to point downward by the camera pitch angle, the processor can adjust a carrier (e.g., a gimbal) coupled to the movable object and the camera to cause the camera to point downward by the camera pitch angle when the movable object accelerates.

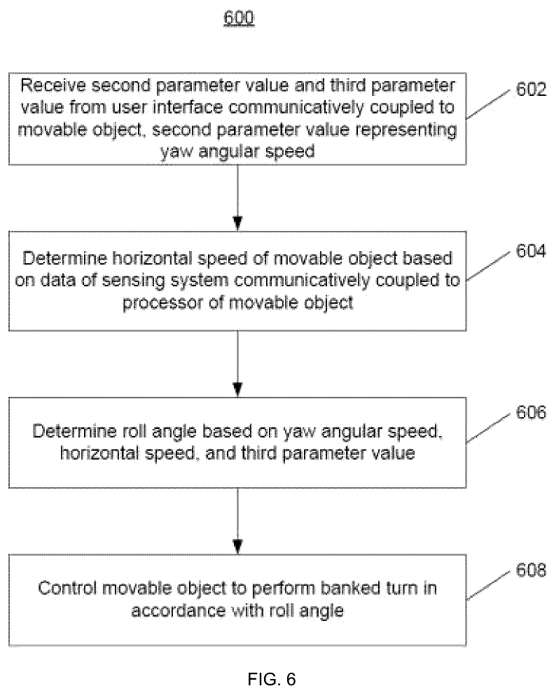

FIG. 6 illustrates a flowchart of an example method 600 for controlling turning of a movable object, consistent with some exemplary embodiments of this disclosure. At step 602, a processor (e.g., controller 103 in FIG. 1) associated with a movable object (e.g., movable object 102) receives (e.g., via communication system 105 in FIG. 1) the second parameter value (i.e., the yaw angular speed parameter value) and a third parameter value (i.e., the optional parameter value) from a user interface communicatively coupled to the movable object. The second parameter value represents a yaw angular speed (e.g., ω_{cmd} as described in association with Eq. (1)). In some exemplary embodiments, the third parameter value can represent a user-input roll angle (e.g., ϕᵤₛₑᵣ as described with reference to Eq. (7)). For example, the movable object can include an unmanned aerial vehicle (UAV). In some exemplary embodiments, the user interface can be communicatively coupled to the movable object via a wireless network (e.g., network 120 in FIG. 1). In some exemplary embodiments, the user interface can include a physical user interface on a remote controller (e.g., remote controller 130 in FIG. 1) or a graphical user interface (GUI) on a screen (e.g., display device 131 or a screen of mobile device 140 in FIG. 1).

In some exemplary embodiments, as described above, the user interface can include a control module including a movable part having a neutral position. For example, the control module can include a physical stick (e.g., a joystick), a lever, a switch, a knob, a slider, a wheel, a wearable apparatus, a touchable display, a button, or any physical or virtual module that includes a movable part having a neutral position. For example, if the control module is a joystick, the movable part can be a control column.

Still referring to FIG. 6, at step 604, the processor determines a horizontal speed (e.g., vₓ as described in Eq. (2)) of the movable object based on data of a sensing system (e.g., sensing system 101 in FIG. 1) communicatively coupled to the processor. For example, the data received from the sensing system can include positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object.

At step 606, the processor determines a roll angle (e.g., ϕ_{cmd} as described with reference to Eqs. (1) to (13)) based on the yaw angular speed, the horizontal speed, and the third parameter value (i.e., the optional parameter value). In some exemplary embodiments, the processor can determine a yaw angular speed (e.g., ω_{cmd} as described in association with Eq. (1)) based on an input yaw angle (e.g., ψᵤₛₑᵣ as described in association with Eq. (1)). The processor can then determine a centripetal acceleration (e.g., a_{y} as described with reference to Eq. (2)) based on the yaw angular speed and the horizontal speed. The processor can further determine the roll angle based on the centripetal acceleration and the third parameter value, in which the third parameter value represents a user-input roll angle.

In some exemplary embodiments, to determine the centripetal acceleration based on the yaw angular speed and the horizontal speed, the processor can determine a filtered yaw angular speed (e.g., ω_{filtered} as described with reference to Eq. (3)) by applying a first low-pass filter (e.g., lpf₁(⋅) as described with reference to Eq. (3)) to the yaw angular speed, and determine the centripetal acceleration (e.g., a_{y} as described in Eq. (4)) based on the filtered yaw angular speed and the horizontal speed.

In some exemplary embodiments, to determine the centripetal acceleration based on the yaw angular speed and the horizontal speed, the processor can receive a predetermined coefficient (e.g., k as described in Eq. (5)) associated with a slip angle (e.g., slip angle 310 in FIG. 3) or a skid angle (e.g., skid angle 306 in FIG. 3) from the user interface. The processor can then determine the centripetal acceleration (e.g., a_{ycmd} as described in Eq. (5)) based on the predetermined coefficient, the yaw angular speed, and the horizontal speed.

In some exemplary embodiments, to determine the roll angle (e.g., ϕ_{cmd}), the processor determines an inclination angle (e.g., ϕ_{ffd} as described with reference to Eq. (6)) based on the second parameter value (i.e., the yaw angular speed parameter value) and the horizontal speed. The processor determines the roll angle based on the inclination angle and the user-input roll angle. For example, the processor can determine the roll angle (e.g., ϕ_{cmd} as described with reference to Eq. (7)) as a sum of the inclination angle and the user-input roll angle.

In some exemplary embodiments, to determine the roll angle (e.g., ϕ_{cmd}) based on the inclination angle and the user-input roll angle, the processor determines an input speed (e.g., the input lateral speed v_{bcmd} as described with reference to Eq. (8)) based on the user-input roll angle. For example, the processor can determine (e.g., based on Eq. (11) or (12)) the input speed based on at least one of the user-input roll angle or the centripetal acceleration. The processor then determines a speed (e.g., the lateral speed v_{b} as described with reference to Eq. (9)) of the movable object based on the data of the sensing system. The processor then determines an adjusted roll angle speed (e.g., ϕ_{ctrl} as described with reference to Eq. (9)) based on the input speed and the speed of the movable object. For example, the processor can determine the adjusted roll angle using a first control loop of a closed-loop controller (e.g., a PID controller) communicatively coupled to the processor, in which the first control loop can be nested inside a second control loop of the closed-loop controller. After that, the processor determines the roll angle (e.g., ϕ_{cmd} as described with reference to Eq. (10)) as a sum of the inclination angle and the adjusted roll angle.

Still referring to FIG. 6, at step 608, the processor controls the movable object to perform a banked turn in accordance with the roll angle. In some exemplary embodiments, the processor can control the movable object to perform the banked turn with the slip angle or the skid angle based on the predetermined coefficient.

In some exemplary embodiments, in response to the second parameter value (i.e., the yaw angular speed parameter value) changing to represent a substantially zero yaw angular speed (e.g., being within a range of ±0.1 rad/s), the processor determines a filtered roll angle (e.g., ϕ_{filtered} as described with reference to Eq. (13)) by applying a second low-pass filter (e.g., lpf₂( ) as described with reference to Eq. (13)) to the roll angle. Then, the processor can control the movable object to perform the banked turn in accordance with the filtered roll angle.

Consistent with some exemplary embodiments of method 600, the processor further determines a current roll angle (e.g., ϕ in FIGS. 4A-4C) of the movable object based on the data of the sensing system. After that, the processor can control to adjust a posture (e.g., a roll angle, a yaw angle, a pitch angle, or any combination thereof) of the movable object based on the roll angle and the current roll angle.

Consistent with some exemplary embodiments of method 600, the processor can control the movable object to move in a first control mode in response to receiving (e.g., via communication system 105 in FIG. 1) a first control-mode signal from the user interface. The first control mode can include setting a range to at least one of the horizontal speed (e.g., vₓ), the input yaw angle (e.g., ψᵤₛₑᵣ), the yaw angular speed (e.g., ω_{cmd}), or the predetermined coefficient (e.g., k).

Consistent with some exemplary embodiments of method 600, the processor can control the movable object to move in a second control mode in response to receiving (e.g., via communication system 105 in FIG. 1) a second control-mode signal from the user interface. The second control mode can include increasing at least one of a value of the predetermined coefficient (e.g., k) or a bandwidth (e.g., a gain) of a control loop (e.g., a velocity control loop) of a closed-loop controller (e.g., a PID controller) communicatively coupled to the processor.

Consistent with some exemplary embodiments of method 600, the processor can control the movable object to move in a third control mode in response to receiving (e.g., via communication system 105 in FIG. 1) a third control-mode signal from the user interface. The third control mode can include decreasing at least one of the value of the predetermined coefficient (e.g., k) or a bandwidth (e.g., a gain) of a control loop of a closed-loop controller (e.g., a PID controller) communicatively coupled to the processor in response to the second parameter value (i.e., the yaw angular speed parameter value) representing a non-zero yaw angular speed, and increasing the bandwidth in response to the second parameter value changing to represent a substantially zero yaw angular speed (e.g., being within a range of ±0.1 rad/s).

Consistent with some exemplary embodiments of method 600, the processor can further perform any combination of steps (e.g., any of steps 502-506) or operations of method 500.

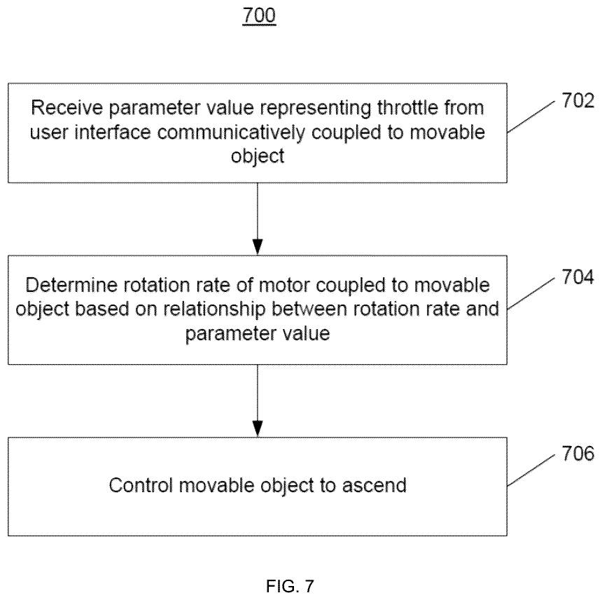

FIG. 7 illustrates a flowchart of an example method 700 for controlling a vertical speed of a movable object, consistent with some exemplary embodiments of this disclosure. At step 702, a processor (e.g., controller 103 in FIG. 1) associated with a movable object (e.g., movable object 102) receives (e.g., via communication system 105 in FIG. 1) the fourth parameter value (i.e., the throttle parameter value) representing a throttle from a user interface communicatively coupled to the movable object. For example, the movable object can include an unmanned aerial vehicle (UAV). In some exemplary embodiments, the user interface can be communicatively coupled to the movable object via a wireless network (e.g., network 120 in FIG. 1). In some exemplary embodiments, the user interface can include a physical user interface on a remote controller (e.g., remote controller 130 in FIG. 1) or a graphical user interface (GUI) on a screen (e.g., display device 131 or a screen of mobile device 140 in FIG. 1).

In some exemplary embodiments, the user interface can include a control module including a movable part having a neutral position. For example, the control module can include a physical stick (e.g., a joystick), a lever, a switch, a knob, a slider, a wheel, a wearable apparatus, a touchable display, a button, or any physical or virtual module that includes a movable part having a neutral position. For example, if the control module is a joystick, the movable part can be a control column.

In some exemplary embodiments, the processor can receive the fourth parameter value from the control module. As described above, the fourth parameter value (also referred to herein as “the throttle parameter value”) represents a displacement of the movable part from the neutral position in a direction (e.g., a forward, backward, left, or right direction, or any combination thereof).

Still referring to FIG. 7, at step 704, the processor determines a rotation rate of a motor (e.g., a motor of any of propulsion devices 205 in FIG. 2) coupled to the movable object based on a relationship (e.g., a linear or nonlinear relationship) between the rotation rate and the fourth parameter value (i.e., the throttle parameter value). For example, the motor can be configured to drive a propeller (e.g., any of rotary components 207 in FIG. 2). In some exemplary embodiments, the control module can be configured to control the rotation rate of the motor. In some exemplary embodiments, the processor can determine the rotation rate of the motor based on the relationship (e.g., a linear relationship) when the direction is a first direction (e.g., a forward direction).

Still referring to FIG. 7, at step 706, the processor controls the movable object to ascend. The motor can operate in accordance with the rotation rate.

Consistent with some exemplary embodiments of method 700, the processor can further determine a vertical target speed based on the fourth parameter value (i.e., the throttle parameter value) when the direction is a second direction (e.g., a backward direction) different from the first direction or when the fourth parameter value represents that the movable part is at the neutral position. The processor can then control the movable object to move at the vertical target speed.

In an example, the vertical target speed can be zero when the fourth parameter value (i.e., the throttle parameter value) represents that the movable part is at the neutral position. In such a case, the processor can control the movable object to stop in a vertical direction using a first control loop (e.g., a vertical velocity control loop) of a closed-loop controller (e.g., a PID controller) communicatively coupled to the processor. The first control loop can be nested inside a second control loop (e.g., a position control loop) of the closed-loop controller.

In another example, the vertical target speed can be non-zero when the direction is the second direction. In such a case, the processor can control the movable object to accelerate or decelerate to the vertical target speed in accordance with a constant acceleration. For example, the processor can control the movable object to accelerate or decelerate in a vertical direction using a second control loop (e.g., a position control loop) and a third control loop (e.g., a vertical acceleration control loop) of a closed-loop controller communicatively coupled to the processor. The third control loop can be nested inside the second control loop.

Consistent with some exemplary embodiments of method 700, the processor can further perform any combination of steps (e.g., any of steps 502-506) or operations of method 500 or steps (e.g., any of steps 602-608) or operations of method 600.

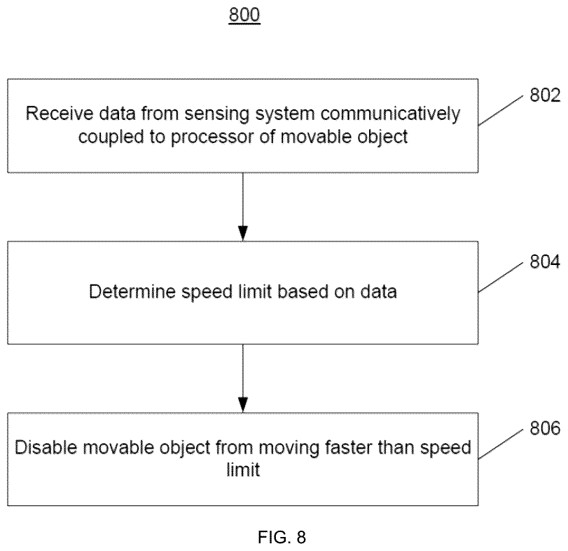

FIG. 8 illustrates a flowchart of an example method 800 for providing safety protection to a movable object, consistent with some exemplary embodiments of this disclosure. At step 802, a processor (e.g., controller 103 in FIG. 1) associated with a movable object (e.g., movable object 102) receives (e.g., via communication system 105 in FIG. 1) data from a sensing system (e.g., sensing system 101 in FIG. 1) communicatively coupled to the processor. In some exemplary embodiments, the movable object can include an unmanned aerial vehicle (UAV). For example, the data received from the sensing system can include positional data (e.g., relative location, orientation, attitude, linear displacement, or angular displacement), velocity data (e.g., a linear velocity or speed, or an angular velocity or speed), acceleration data (e.g., a linear acceleration or an angular acceleration), or any data relating to a motion status of the movable object.

At step 804, the processor determines a speed limit based on the data. At step 806, the processor disables the movable object from moving faster than the speed limit. For example, the processor can disable the movable object by causing it to decelerate to the speed limit when a speed of the movable object is higher than the speed limit.

Consistent with some exemplary embodiments of method 800, the data can include an altitude of the movable object above a ground, and the speed limit can include a vertical speed limit. In such cases, the processor can determine the vertical speed limit based on the altitude when the altitude is below a first threshold altitude. Then, the processor can disable the movable object from moving toward the ground faster than the vertical speed limit. In some exemplary embodiments, the processor can control the movable object to stop moving toward the ground when the altitude is below a second threshold altitude. For example, the second threshold altitude can be lower than the first threshold altitude.

Consistent with some exemplary embodiments of method 800, the data can include a distance between the movable object and an obstacle in front of the movable object, and the speed limit can include a horizontal speed limit. In such cases, the processor can determine the horizontal speed limit based on the distance when the distance is closer than a first threshold distance. Then, the processor can disable the movable object from moving toward the obstacle faster than the horizontal speed limit. In some exemplary embodiments, the processor can control the movable object to stop moving toward the obstacle when the distance is closer than a second threshold distance. For example, the second threshold distance can be shorter than the first threshold distance.

Consistent with some exemplary embodiments of method 800, in response to receiving (e.g., via communication system 105 in FIG. 1) a stop signal from a user interface communicatively coupled to the movable object, the processor can control the movable object to stop in at least one of a horizontal direction or a vertical direction. In some exemplary embodiments, to control the movable object to stop, the processor can control to increase at least one of a bandwidth (e.g., a gain) of a first control loop (e.g., a horizontal velocity control loop) of a closed-loop controller (e.g., a PID controller) communicatively coupled to the processor or a bandwidth (e.g., a gain) of a second control loop (e.g., a vertical velocity control loop) of the closed-loop controller. The first control loop can be configured to control a horizontal movement of the movable object, and the second control loop can be configured to control a vertical movement of the movable object.

In some exemplary embodiments, the user interface can be communicatively coupled to the movable object via a wireless network (e.g., network 120 in FIG. 1). In some exemplary embodiments, the user interface can include a physical user interface on a remote controller (e.g., remote controller 130 in FIG. 1) or a graphical user interface (GUI) on a screen (e.g., display device 131 or a screen of mobile device 140 in FIG. 1). In some exemplary embodiments, the user interface can include a physical stick (e.g., a joystick), a lever, a switch, a knob, a slider, a wheel, a button, or any physical or virtual control module.

Consistent with some exemplary embodiments of method 800, the processor can further perform any combination of steps (e.g., any of steps 502-506) or operations of method 500, steps (e.g., any of steps 602-608) or operations of method 600, or steps (e.g., any of steps 702-706) or operations of method 700.

Consistent with some exemplary embodiments of this disclosure, the above-described methods (e.g., method 800) for providing safety protection to the operations of the movable object can be combined with the above-described methods for controlling the horizontal speed of the movable object (e.g., method 500), the above-described methods for controlling the vertical speed of the movable object (e.g., method 700), and/or the above-described methods for controlling turning of the movable object (e.g., method 600), so as to provide a technical solution for the safety protection and control any combination of the turning, the horizontal speed, and the vertical speed of the movable object. It should be noted that such a combination can be implemented in any arrangement, and this disclosure does not limit the manners of combining the operations of such embodiments.

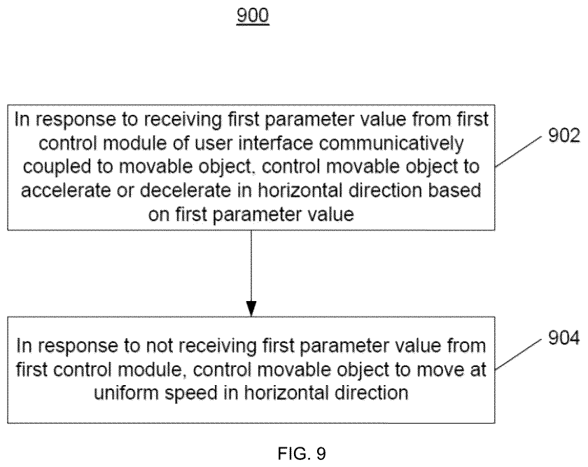

FIG. 9 illustrates a flowchart of an example method 900 for controlling a movable object, consistent with some exemplary embodiments of this disclosure. At step 902, in response to receiving a first parameter value from a first control module of a user interface communicatively coupled to a movable object (e.g., movable object 102), a processor (e.g., controller 103 in FIG. 1) associated with the movable object controls the movable object to accelerate or decelerate in a horizontal direction based on the first parameter value. The movable object can be in a first control mode. In some exemplary embodiments, the first control module can include a joystick, a button, or a wheel. In some exemplary embodiments, the first parameter value can represent a pitch angle.

For example, the movable object can include an unmanned aerial vehicle (UAV). In some exemplary embodiments, the user interface can be communicatively coupled to the movable object via a wireless network (e.g., network 120 in FIG. 1). In some exemplary embodiments, the user interface can include a physical user interface on a remote controller (e.g., remote controller 130 in FIG. 1) or a graphical user interface (GUI) on a screen (e.g., display device 131 or a screen of mobile device 140 in FIG. 1).

In some exemplary embodiments, an acceleration value or a deceleration value of the movable object can increase when the first parameter value increases, and the acceleration value or the deceleration value of the movable object can decrease when the first parameter value decreases. Assuming the first parameter value represents a pitch angle, in an example, if the movable object is accelerating forward (e.g., with its nose pointing below horizontal), when the first parameter value increases, it can represent that the pitch angle of the movable object is to increase towards a downward direction (e.g., the nose of the movable object lowering below horizontal), and the movable object can accelerate forward with an increasing acceleration value (e.g., the acceleration itself becoming larger). As another example, if the movable object is decelerating forward (e.g., with its nose pointing above horizontal), when the first parameter value increases, it can represent that the pitch angle of the movable object is to increase towards an upward direction (e.g., the nose of the movable object raising above horizontal), and the movable object can decelerate forward with an increasing deceleration value (e.g., the deceleration itself becoming larger).

As another example, if the movable object is accelerating forward (e.g., with its nose pointing below horizontal), when the first parameter value decreases, it can represent that the pitch angle of the movable object is to decrease towards an upward direction (e.g., the nose of the movable object raising above horizontal), and the movable object can accelerate forward with a decreasing acceleration value (e.g., the acceleration itself becoming smaller). In another example, if the movable object is decelerating forward (e.g., with its nose pointing above horizontal), when the first parameter value decreases, it can represent that the pitch angle of the movable object is to decrease towards a downward direction (e.g., the nose of the movable object lowering below horizontal), and the movable object can decelerate forward with a decreasing deceleration value (e.g., the deceleration itself becoming smaller).

At step 904, in response to not receiving the first parameter value from the first control module, the processor controls the movable object to move at a uniform speed (e.g., a constant speed) in the horizontal direction. For example, if a user stops manipulating the first control module, the processor can no longer receive the first parameter value. In such cases, the processor controls the movable object to move at the uniform speed, in which the magnitude of the speed and the direction of the speed is unchanged.

Consistent with some exemplary embodiments of method 900, in response to receiving a second parameter value (i.e., the yaw angular speed parameter value) from a second control module of the user interface, the processor can further control the movable object to perform a banked turn based on the second parameter value. For example, the second parameter value can represent a yaw angular speed. In some exemplary embodiments, the second control module can include another one of joystick, a button, or a wheel.

In some exemplary embodiments, curvature of the banked turn can increase when the second parameter value (i.e., the yaw angular speed parameter value) increases, and the curvature of the banked turn can decrease when the second parameter value decreases. Assuming the second parameter value represents a yaw angular speed, in an example, if the movable object is making a slipping turn, when the second parameter value increases, it can represent that the yaw angular speed of the movable object is to increase, and the movable object can perform the banked turn with a greater curvature (e.g., with a decreasing slip angle). As another example, if the movable object is making a skidding turn, when the second parameter value increases, it can represent that the yaw angular speed of the movable object is to increase, and the movable object can perform the banked turn with a greater curvature (e.g., with an increasing skid angle). In yet another example, if the movable object is making the banked turn without slipping or skidding, when the second parameter value increases, it can represent that the yaw angular speed of the movable object is to increase, and the movable object can perform the banked turn with a greater curvature (e.g., with an increasing inclination angle).

As another example, if the movable object is making a slipping turn, when the second parameter value (i.e., the yaw angular speed parameter value) decreases, it can represent that the yaw angular speed of the movable object is to decrease, and the movable object can perform the banked turn with a smaller curvature (e.g., with an increasing slip angle). As another example, if the movable object is making a skidding turn, when the second parameter value decreases, it can represent that the yaw angular speed of the movable object is to decrease, and the movable object can perform the banked turn with a smaller curvature (e.g., with a decreasing skid angle). In yet another example, if the movable object is making the banked turn without slipping or skidding, when the second parameter value decreases, it can represent that the yaw angular speed of the movable object is to decrease, and the movable object can perform the banked turn with a smaller curvature (e.g., with a decreasing inclination angle).

Consistent with some exemplary embodiments of method 900, in response to receiving a third parameter value (i.e., the optional parameter value) from a third control module of the user interface, the processor can further control the movable object to perform the banked turn with a slip angle or a skid angle based on the third parameter value. For example, the third parameter value can represent a user-input roll angle. In some exemplary embodiments, the third control module can include another one of joystick, a button, or a wheel.

In some exemplary embodiments, curvature of the banked turn can increase when the third parameter value (i.e., the optional parameter value) increases, and the curvature of the banked turn can decrease when the third parameter value decreases. Assuming the third parameter value represents a user-input roll angle, in an example, if the movable object is making a slipping turn, when the third parameter value increases, it can represent that the roll angle of the movable object is to increase by the user-input roll angle, and the movable object can perform the banked turn with a greater curvature (e.g., with a decreasing slip angle). As another example, if the movable object is making a skidding turn, when the third parameter value increases, it can represent that the roll angle of the movable object is to increase by the user-input roll angle, and the movable object can perform the banked turn with a greater curvature (e.g., with an increasing skid angle). In yet another example, if the movable object is making the banked turn without slipping or skidding, when the third parameter value increases, it can represent that the roll angle of the movable object is to increase by the user-input roll angle, and the movable object can perform the banked turn with a greater curvature (e.g., with its roll angle increased by the user-input roll angle).

As another example, if the movable object is making a slipping turn, when the third parameter value (i.e., the optional parameter value) decreases, it can represent that the roll angle of the movable object is to decrease by the user-input roll angle, and the movable object can perform the banked turn with a smaller curvature (e.g., with an increasing slip angle). As another example, if the movable object is making a skidding turn, when the third parameter value decreases by the user-input roll angle, it can represent that the user-input roll angle of the movable object is to decrease, and the movable object can perform the banked turn with a smaller curvature (e.g., with a decreasing skid angle). In yet another example, if the movable object is making the banked turn without slipping or skidding, when the third parameter value decreases, it can represent that the roll angle of the movable object is to decrease by the user-input roll angle, and the movable object can perform the banked turn with a smaller curvature (e.g., with its roll angle decreased by the user-input roll angle).

Consistent with some exemplary embodiments of method 900, in response to receiving a fourth parameter value (i.e., the throttle parameter value) from a fourth control module of the user interface, the processor can control the movable object to ascend by controlling a rotation rate of a motor coupled to the movable object based on the fourth parameter value. In some exemplary embodiments, the fourth control module can include another one of joystick, a button, or a wheel. It should be noted that each of the first control module, the second control module, the third control module, and the fourth control module can be any one of a joystick, a button, or a wheel, and is not limited to the examples described herein.

For example, the fourth parameter value can represent a throttle. In some exemplary embodiments, the rotation rate of the motor can increase when the fourth parameter value increases (e.g., representing an increasing throttle), and the rotation rate of the motor can decrease when the fourth parameter value decreases (e.g., representing a decreasing throttle).

Consistent with some exemplary embodiments of method 900, in response to receiving the first parameter value from the first control module of the user interface, the processor can further adjust a pitch angle of a carrier coupled to the movable object. The carrier can carry a camera.

Consistent with some exemplary embodiments of method 900, in response to receiving a control-mode signal, the processor can further switch a control mode of the movable object from the first control mode to a second control mode. After switching to the second control mode, in response to receiving the first parameter value from the first control module of the user interface, the processor can control the movable object in the second control mode to move forward or backward in the horizontal direction based on the first parameter value. In response to not receiving the first parameter value from the first control module of the user interface, the processor can control the movable object in the second control mode to move at a substantially zero horizontal speed (e.g., being within a range of ±1 cm/s). For example, when a user stops manipulating the first control module, the processor can no longer receive the first parameter value. In such cases, the processor controls the movable object to move at move at the substantially zero horizontal speed (e.g., braking to stop).

Assuming the first parameter value represents a pitch angle, in an example, if the movable object is moving forward (e.g., with its nose pointing below horizontal), when the first parameter value increases, it can represent that the pitch angle of the movable object is to increase towards a downward direction (e.g., the nose of the movable object lowering below horizontal), and the movable object can move forward with an increasing speed (e.g., the speed increasing with a constant acceleration). As another example, if the movable object is moving backward (e.g., with its nose pointing above horizontal), when the first parameter value increases, it can represent that the pitch angle of the movable object is to increase towards an upward direction (e.g., the nose of the movable object raising above horizontal), and the movable object can move backward with an increasing speed (e.g., the speed increasing with a constant acceleration).

As another example, if the movable object is moving forward (e.g., with its nose pointing below horizontal), when the first parameter value decreases, it can represent that the pitch angle of the movable object is to decrease towards an upward direction (e.g., the nose of the movable object raising above horizontal), and the movable object can move forward with a decreasing speed (e.g., the speed decreasing with a constant deceleration). As another example, if the movable object is moving backward (e.g., with its nose pointing above horizontal), when the first parameter value decreases, it can represent that the pitch angle of the movable object is to decrease towards a downward direction (e.g., the nose of the movable object lowering below horizontal), and the movable object can move backward with a decreasing speed (e.g., the speed decreasing with a constant deceleration).

Consistent with some exemplary embodiments of method 900, in response to a predetermined condition being met, the processor can further switch a control mode of the movable object from the first control mode to a second control mode. The predetermined condition can include at least one of a condition that the movable object moves at a speed below a predetermined speed limit or a condition that an altitude of the movable object is below a predetermined altitude limit. After switching to the second control mode, in response to receiving the first parameter value from the first control module of the user interface, the processor can control the movable object in the second control mode to move forward or backward in the horizontal direction based on the second parameter value (i.e., the yaw angular speed parameter value). In response to not receiving the first parameter value from the first control module of the user interface, the processor can control the movable object in the second control mode to move at a substantially zero horizontal speed (e.g., being within a range of ±1 cm/s).

Consistent with some exemplary embodiments of method 900, in response to the movable object enabling a control mode, the processor can further set the control mode to be the second control mode by default. In response to receiving the first parameter value from the first control module of the user interface, the processor can control the movable object in the second control mode to move forward or backward in the horizontal direction based on the second parameter value (i.e., the yaw angular speed parameter value). In response to not receiving the first parameter value from the first control module of the user interface, the processor can control the movable object in the second control mode to move at a substantially zero horizontal speed (e.g., being within a range of ±1 cm/s). In response to receiving a control-mode signal, the processor can switch the control mode of the movable object from the second control mode to the first control mode.

Consistent with some exemplary embodiments of method 900, in response to detecting (e.g., through a sensing system communicatively coupled to the processor) an environment of the movable object meeting a predetermined condition, the processor can further set a control mode of the movable object to be the first control mode. Alternatively, in response to detecting (e.g., through a sensing system communicatively coupled to the processor) the environment of the movable object meeting the predetermined condition, the processor can further perform the following operations. The processor can send data (e.g., to the user interface) for indicating to switch the control mode. In response to receiving data representing confirmation (e.g., by a user) to switch the control mode, the processor can set the control mode to be the first control mode. By way of example, the predetermined condition of the environment can include a crosswind, an obstacle being on or near a flight path of the movable object, the movable object approaching a regulation-forbidden zone, or any other condition that represents an environment change that can potentially affect safety and regulation compliance of the movable object.

Consistent with some exemplary embodiments of method 900, the processor can further set a control mode of the movable object to be the first control mode based on a control action on the first control module of the user interface. For example, the control action on the first control module can be performed by a user, such as toggling a switch, pressing a button, turning a wheel, or any action on the first control module. Alternatively, the processor can set the control mode of the movable object to be the first control mode based on an environment (e.g., detected through a sensing system communicatively coupled to the processor) of the movable object.

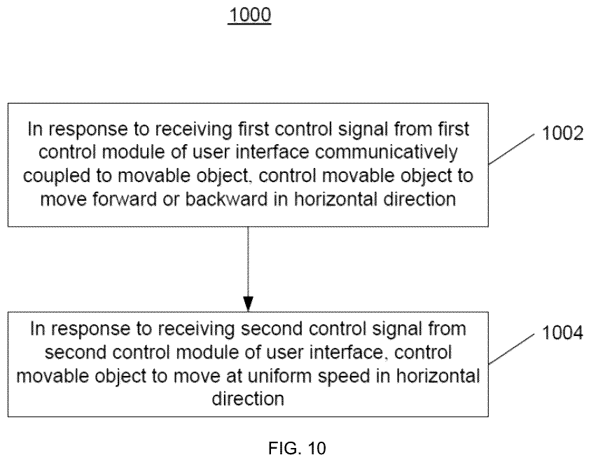

FIG. 10 illustrates a flowchart of another example method 1000 for controlling a movable object, consistent with some exemplary embodiments of this disclosure. At step 1002, in response to receiving a first control signal from a first control module (e.g., representing a pitch angle) of a user interface communicatively coupled to the movable object, the processor controls the movable object to move forward or backward in the horizontal direction. At step 1004, in response to receiving a second control signal (e.g., representing a braking signal) from a second control module of a user interface, the processor controls the movable object to move at a uniform speed in the horizontal direction. For example, the second control signal can represent a braking signal. In response to the braking signal, the processor can control the movable object to stop accelerating or decelerating and to move at the uniform speed (e.g., in the horizontal direction, in a vertical direction, or in any direction). In some exemplary embodiments, the first control module can include a joystick, a button, or a wheel, and the second control module can include a joystick, a button, or a wheel. In some exemplary embodiments, a speed of the movable object can increase when the first control signal increases, and the speed of the movable object can decrease when the first control signal decreases.

Consistent with some exemplary embodiments of this disclosure, a non-transitory computer-readable storage medium storing a set of instructions is also provided, and the instructions can be executed by one or more processors of one or more apparatuses (e.g., movable object 102, remote controller 130, mobile device 140, or server 110 in FIG. 1) for performing the above-described methods (e.g., any combination of methods 500-1000). Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The one or more apparatuses can include one or more processors, input/output interfaces, network interfaces, or memories, or any combination thereof.

While first-fourth parameters have been disclosed herein as corresponding to particular parameter values, the disclosure is not so limited. Embodiments can be practiced with equal effectiveness utilizing other parameters as the first-fourth parameters that facilitate control of the movable object.

It is appreciated that the above-described exemplary embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units can be combined as one module/unit, and each of the above-described modules/units can be further divided into a plurality of sub-modules/sub-units.

It is intended that the sequence of steps shown in figures are only for illustrative purposes and are not intended to be limited to any particular sequence of steps. As such, those skilled in the art can appreciate that these steps can be performed in a different order while implementing the same method.

It will be apparent to those skilled in the art that various modifications and variations can be made to the disclosed devices and systems. Other embodiments will be apparent to those skilled in the art from consideration of the specification and practice of the disclosed devices and systems. It is intended that the specification and examples be considered as example only, with a true scope being indicated by the following claims and their equivalents.

What is claimed is:

1. A method implemented by a processor associated with a movable object for controlling a movable object, comprising:
in response to receiving a first parameter value from a first control module of a user interface communicatively coupled to the movable object, controlling the movable object to accelerate or decelerate in a horizontal direction based on the first parameter value; and
in response to not receiving the first parameter value from the first control module, controlling the movable object to move at a uniform speed in the horizontal direction.

2. The method of claim 1, further comprising:
in response to receiving a second parameter value from a second control module of the user interface, controlling the movable object to perform a banked turn based on the second parameter value.

3. The method of claim 2, wherein curvature of the banked turn increases when the second parameter value increases, and the curvature of the banked turn decreases when the second parameter value decreases.

4. The method of claim 2, further comprising:
in response to receiving a third parameter value from a third control module of the user interface, controlling the movable object to perform the banked turn with a slip angle or a skid angle based on the third parameter value.

5. The method of claim 4, wherein curvature of the banked turn increases when the third parameter value increases, and the curvature of the banked turn decreases when the third parameter value decreases.

6. The method of claim 1, further comprising:
in response to receiving a fourth parameter value from a fourth control module of the user interface, controlling the movable object to ascend by controlling a rotation rate of a motor coupled to the movable object based on the fourth parameter value.

7. The method of claim 6, wherein the rotation rate of the motor increases when the fourth parameter value increases, and the rotation rate of the motor decreases when the fourth parameter value decreases.

8. The method of claim 1, further comprising:
in response to receiving the first parameter value from the first control module of the user interface, adjusting a pitch angle of a carrier coupled to the movable object, wherein the carrier carries a camera.

9. The method of claim 1, further comprising:
in response to receiving a control-mode signal, switching a control mode of the movable object from a first control mode to a second control mode, wherein the first control mode and the second control mode have different control logic for controlling the movable object to move;
in response to receiving the first parameter value from the first control module of the user interface, controlling the movable object in the second control mode to move forward or backward in the horizontal direction based on the first parameter value; and
in response to not receiving the first parameter value from the first control module of the user interface, controlling the movable object in the second control mode to move at a substantially zero horizontal speed.

10. The method of claim 1, further comprising:
in response to a predetermined condition being met, switching a control mode of the movable object from a first control mode to a second control mode, wherein the first control mode and the second control mode have different control logic for controlling the movable object to move, and wherein the predetermined condition includes at least one of a condition that the movable object moves at a speed below a predetermined speed limit, or a condition that an altitude of the movable object is below a predetermined altitude limit;
in response to receiving the first parameter value from the first control module of the user interface, controlling the movable object in the second control mode to move forward or backward in the horizontal direction based on the second parameter value; and
in response to not receiving the first parameter value from the first control module of the user interface, controlling the movable object in the second control mode to move at a substantially zero horizontal speed.

11. The method of claim 1, further comprising:
in response to the movable object enabling a control mode, setting the control mode to be a second control mode by default;
in response to receiving the first parameter value from the first control module of the user interface, controlling the movable object in the second control mode to move forward or backward in the horizontal direction based on the second parameter value;
in response to not receiving the first parameter value from the first control module of the user interface, controlling the movable object in the second control mode to move at a substantially zero horizontal speed; and
in response to receiving a control-mode signal, switching the control mode of the movable object from the second control mode to the first control mode.

12. The method of claim 1, further comprising:
in response to detecting an environment of the movable object meeting a predetermined condition, setting a control mode of the movable object to be the first control mode; or
in response to detecting an environment of the movable object meeting the predetermined condition, perform:
sending data for indicating to switch the control mode, and
in response to receiving data representing confirmation to switch the control mode, setting the control mode to be the first control mode.

13. The method of claim 1, wherein the first control module includes at least one of a joystick, a button, or a wheel.

14. The method of claim 1, wherein an acceleration value or a deceleration value of the movable object increases when the first parameter value increases, and the acceleration value or the deceleration value of the movable object decreases when the first parameter value decreases.

15. The method of claim 1, further comprising:
setting a control mode of the movable object to be the first control mode based on a control action on the first control module of the user interface; or
setting a control mode of the movable object to be the first control mode based on an environment of the movable object.

16. An apparatus for controlling a movable object, comprising:
at least one non-transitory storage medium storing a set of instructions for controlling the movable object; and
at least one processor in communication with the at least one non-transitory storage medium, wherein during operation, the at least one processor executes the set of instructions to:
in response to receiving a first parameter value from a first control module of a user interface communicatively coupled to the movable object, control the movable object to accelerate or decelerate in a horizontal direction based on the first parameter value, and
in response to not receiving the first parameter value from the first control module, control the movable object to move at a uniform speed in the horizontal direction.

17. The apparatus according to claim 16, wherein the at least one processor further executes the set of instructions to:
in response to receiving a second parameter value from a second control module of the user interface, control the movable object to perform a banked turn based on the second parameter value.

18. The apparatus according to claim 16, wherein the at least one processor further executes the set of instructions to:
in response to receiving a fourth parameter value from a fourth control module of the user interface, control the movable object to ascend by controlling a rotation rate of a motor coupled to the movable object based on the fourth parameter value.

19. The apparatus according to claim 16, wherein the at least one processor further executes the set of instructions to:
in response to receiving the first parameter value from the first control module of the user interface, adjust a pitch angle of a carrier coupled to the movable object, wherein the carrier carries a camera.

20. A system, comprising:
a movable object; and
a user interface, communicatively coupled to the movable object, wherein
the movable object includes:
at least one non-transitory storage medium storing a set of instructions for controlling the movable object; and
at least one processor in communication with the at least one non-transitory storage medium, wherein during operation, the at least one processor executes the set of instructions to:
in response to receiving a first parameter value from a first control module of the user interface, control the movable object to accelerate or decelerate in a horizontal direction based on the first parameter value, and
in response to not receiving the first parameter value from the first control module, control the movable object to move at a uniform speed in the horizontal direction.
